(19) United States
(12) Patent Application Publication
(10) Pub. No.: US 2023/0102797 A1
(43) Pub. Date: Mar. 30, 2023

(54) FREEFORM CONTACT LENSES FOR MYOPIA MANAGEMENT

(71) Applicants: Nthalmic Holding Pty Ltd, Sydney NSW (AU); Brighten Optix Corp., Taipei City (TW)

(72) Inventors: Ravi Chandra Bakaraju, Sydney NSW (AU); Klaus Ehrmann, Sydney NSW (AU); Darrin Falk, Sydney NSW (AU)

(21) Appl. No.: 17/799,592

(22) PCT Filed: Feb. 6, 2021
(86) PCT No.: PCT/AU2021/050099

§ 371 Date: Aug. 12, 2022

(30) Foreign Application Priority Data
Feb. 14, 2020 (AU) 2020900414

(51) Int. Cl. G02C 7/04

(52) U.S. Cl. CPC G02C 7/042; G02C 7/048; G02C 2202/04; G02C 2202/24

(57) ABSTRACT

The present disclosure relates to a contact lens for managing myopia wherein the contact lens comprises of an optical zone about an optical axis and a non-optical peripheral carrier zone about the optical zone; wherein the optical zone is configured with a substantially single vision power profile providing correction for the eye, and a decentred second region configured with one or more meridionally and azimuthally variant power distributions, wherein at least one of the meridionally and azimuthally variant power distribution is devoid of mirror symmetry, the second region located substantially away from the optical centre and configured to provide at least in part a regional conoid of partial blur producing an optical stop signal for the eye; and wherein the non-optical peripheral carrier zone is configured with a thickness profile that is substantially rotationally symmetric to further provide a temporally and spatially varying stop signals to reduce myopia progression.

### CROSS-REFERENCE

This application claims priority to Australian Provisional Application Serial No. 2020/900414 filed on Feb. 14, 2020, entitled “A freeform lens design” and is a continuation of the PCT/AU2020/051006 filed on Sep. 23, 2020, entitled “A freeform contact lens solution for myopia”; both of which are herein incorporated by reference in their entirety.

### FIELD OF THE INVENTION

The present disclosure relates to contact lenses for use with eyes experiencing eye-length related disorders, like myopia. This invention relates to a contact lens for managing myopia wherein the contact lens comprises of an optical zone about an optical axis; and a non-optical peripheral carrier zone about the optical zone; wherein the optical zone is configured with a substantially single vision power profile providing a substantial correction for the eye, and a decentred second region configured with one or more meridionally and azimuthally variant power distributions, wherein at least one of the meridionally and azimuthally variant power distribution is devoid of mirror symmetry, the second region located substantially away from the optical centre and configured to provide at least in part directional cues in form of a regional conoid or interval of partial blur producing an optical stop signal on the retina; and wherein the non-optical peripheral carrier zone is configured with a thickness profile that is substantially rotationally symmetric, and/or is configured with at least one rotation assisting feature, to further provide temporally and spatially varying stop signals to decelerate, ameliorate, control, inhibit, or reduce the rate of myopia progression over time.

### BACKGROUND

Human eyes are hyperopic at birth, where the length of the eyeball is too short for the total optical power of the eye. As the person ages from childhood to adulthood, the eyeball continues to grow until the eye's refractive state stabilises.

The growth of the eye is understood to be controlled by a feedback mechanism and regulated predominantly by the visual experience, to match the eye's optics with the eye length and maintain homeostasis. This process is referred to as emmetropisation.

The signals that guide the emmetropisation process are initiated by the modulation of light energy received at the retina. The retinal image characteristics are monitored by a biological process that modulates the signal to start or stop, accelerate, or slow eye growth. This process coordinates between the optics and the eyeball length to achieve or maintain emmetropia. Derailing from this emmetropisation process results in refractive disorders like myopia.

The rate of incidence of myopia is increasing at alarming rates in many regions of the world, particularly in the East Asia region. In myopic individuals, the axial length of the eye is mismatched to the overall power of the eye, leading to distant objects being focused in front of the retina.

A simple pair of negative single vision lenses can correct myopia. While such devices can optically correct the refractive error associated with eye-length, they do not address the underlying cause of the excessive eye growth in myopia progression.

Excessive eye-length in high degrees of myopia is associated with significant vision-threatening conditions like cataract, glaucoma, myopic maculopathy, and retinal detachment. Thus, there remains a need for specific optical devices for such individuals, that not only correct the underlying refractive error but also prevent excessive eye lengthening or progression of myopia substantially consistent over time.

To date, numerous contact lens optical designs have been proposed to control the rate of eye growth, i.e., myopia progression. The following prior art is incorporated by reference. Collins et al in the U.S. Pat. No. 6,045,578 proposed the addition of positive spherical aberration at the foveal plane to provide a stimulus to control the rate of myopia progression. Aller in the U.S. Pat. No. 6,752,499 proposed the use of bifocal contact lenses for myopic participants who exhibit near-point esophoria. Smith et al in the U.S. Pat. No. 7,025,460 proposed the use of lenses that shift the peripheral image shell in front of the peripheral retina.

To et al in the U.S. Pat. No. 7,506,983 proposed a method of producing a secondary myopic image by use of Fresnel optics. Legerton in the U.S. Pat. No. 7,401,922 proposes another method using positive spherical aberration.

Phillips in the U.S. Pat. No. 7,997,725 proposes a method of simultaneous vision, wherein one part of the lens corrects for pre-existing myopia, while another part produces simultaneous myopic defocus signal. Thorn et al in the U.S. Pat. No. 7,803,153 proposes correction of all optical aberrations, including higher-order aberrations to reduce the rate of myopia progression.

Menezes in the U.S. Pat. No. 8,690,319 proposes the use of a constant distance vision power zone in the centre of the optic zone surrounded by a zone that provides positive longitudinal spherical aberration. Holden et al in the U.S. Pat. No. 8,931,897 proposes a method for treating a myopic eye with an inner optic zone and an outer optic zone with additional power to the baseline prescription power. Tse et al in the U.S. Pat. No. 8,950,860, proposes a method for retarding the progression of myopia with a concentric annular multi-zone refractive lens. Bakaraju et al in the U.S. Pat. No. 9,535,263 proposes a lens with multiple modes of higher-order spherical aberrations to control myopia progression.

In summary, contact lens design options for retarding the rate of myopia progression, include simultaneous defocus regions on the lens, lenses with positive spherical aberration, which may also be referred to as peripheral plus lenses, lenses with additional modifications to include both central and peripheral plus regions, lenses that comprise a specific set of higher-order aberrations.

### DEFINITIONS

Terms used herein are generally used by a person skilled in the art, unless otherwise defined in the following:

The term “myopic eye” means an eye that is either already experiencing myopia, is in the stage of pre-myopia, is at risk of becoming myopic, is diagnosed to have a refractive condition that is progressing towards myopia and has astigmatism of less than 1 DC.

The term “progressing myopic eye” means an eye with established myopia that is diagnosed to be progressing, as gauged by either the change in refractive error of at least −0.25 D/year or the change in axial length of at least 0.1 mm/year.

The term “pre myopic eye” or “an eye at risk of becoming myopic” means an eye, which could be emmetropic or low hyperopic at the time but has been identified to have a high risk of becoming myopic based on genetic factors (e.g. both parents are myopic) and/or age (e.g. being low hyperopic at a young age) and/or environmental factors (e.g. time spent outdoors) and/or behavioural factors (e.g. time spent performing near tasks).

The term “optical stop signal” or “stop signal” means an optical signal or directional cue that may facilitate slowing, reversing, arresting, retarding, inhibiting, or controlling the growth of an eye and/or refractive condition of the eye.

The term “spatially varying optical stop signal” means an optical signal or directional cue, provided at the retina, which changes spatially across the retina of the eye.

The term “temporally varying optical stop signal” means an optical signal or directional cue, provided at the retina, which changes with time.

The term “spatially and temporally varying optical stop signal” means an optical signal or directional cue, provided at the retina, which changes with time and spatially across the retina of the eye.

The term “contact lens” means a finished contact lens to be fit on the cornea of a wearer to affect the optical performance of the eye.

The term “optical zone” or “optic zone” means the region on the contact lens which has the prescribed optical effect which includes correction of the refractive error, as well as a second region which provides the optical stimulus to slow the rate of myopia progression. The optical zone may be further distinguished by front and back optic zone. The front and back optic zone mean anterior and posterior surface areas of a contact lens which contribute to the prescribed optical effect, respectively. An optical zone of the contact lens may be circular or elliptical or of an irregular shape.

The terms “second region” or “second region within the optic zone” means another distinct region within the optic zone of the contact lens with a desired or prescribed optical effect that is substantially decentred from the optical centre or the optical axis. The introduction of meridionally and azimuthally variant power distributions within the second region may lead to circular or irregularly shaped second regions, as disclosed herein.

The term “optical centre of the contact lens” or “optic centre of the contact lens” means the geometric centre of the optical zone of the contact lens. The terms geometrical and geometric are essentially the same, as disclosed herein.

The term “optical axis” means the line passing through the optical centre and substantially perpendicular to the plane containing the edge of the contact lens.

The term “blending zone” is the zone that connects or lies between the optical zone and the non-optical peripheral carrier zone, or the zone that connects or lies between the second region and the remainder of the surrounding optic zone. The blend zone may be on the front or the back surface or both surfaces and may be polished or smoothed between the two different adjacent surface curvatures as disclosed herein.

The term “through-focus” generally refers to the space-dimension in front and/or behind the retina, usually measured in image space, in millimetres. However, in some embodiments, a surrogate measure of “through-focus” term referred in the object space and measured in Dioptres or Diopters, generally refers to the same thing, as disclosed herein.

The term “non-optical peripheral carrier zone” is a non-optical zone that connects or lies between the optic zone and the edge of the contact lens. In some embodiments, a blending zone may be used between the optic zone and peripheral carrier zone, as disclosed herein.

The term “radial” in context of describing the second region means in the direction radiating out from the geometric centre to the edge of the second region, defined along an azimuthal angle. The phrase “radial spoke” means a spoke radiating outward from the geometrical centre of the second region to the end of the second region, at a predetermined azimuthal angle.

The phrase “radial power distribution” in context of describing the second region means the one-dimensional power distribution of localised optical power across an arbitrary radial spoke, as disclosed herein.

The phrase “radially invariant power distribution” in context of describing the second region means an arbitrary radial spoke having a substantially uniform power distribution, as disclosed herein.

The phrase “radially variant power distribution” in context of describing the second region means an arbitrary radial spoke having a substantially non-uniform power distribution, as disclosed herein.

The term “meridian” in context of describing the second region means two opposing radial spokes spread across a predetermined azimuthal angle, defined about the geometric centre of the second region, as disclosed herein.

The phrase “meridional power distribution” in context of describing the second region means the one-dimensional power distribution of localised optical power across an arbitrary meridian, as disclosed herein.

The phrase “meridionally invariant power distribution” in context of describing the second region means an arbitrary meridian having a substantially uniform power distribution, as disclosed herein.

The phrase “meridionally variant power distribution” in context of describing the second region means an arbitrary meridian having a substantially non-uniform power distribution, as disclosed herein.

The phrase “meridional power distribution with mirror symmetry” in context of describing the second region means an arbitrary meridian having substantially same power distributions across its two opposing radial spokes.

The phrase “meridional power distribution devoid of mirror symmetry” in context of describing the second region means an arbitrary meridian having two substantially different power distributions across its two opposing radial spokes.

The terms “azimuth or azimuthal angles” in context of describing the second region mean in the direction along the circumference of the second region about the geometric centre of the second region, defined at an arbitrary radial distance from the geometric centre of the second region.

The phrase “azimuthal power distribution” in context of describing the second region means the one-dimensional power distribution of localised optical power across arbitrary azimuthal angles measured at a given radial distance about the geometrical centre of the second region.

The phrase “azimuthally invariant power distribution” in context of describing the second region means that the azimuthal power distribution has a substantially uniform power distribution, as disclosed herein.

The phrase “azimuthally variant power distribution” in context of describing the second region means that the azimuthal power distribution has a substantially non-uniform power distribution, as disclosed herein.

The phrase “azimuthal power distribution with mirror symmetry” in context of describing the second region means that the azimuthal power distribution between 0 and π radians is substantially similar to the azimuthal power distribution between π and 2π radians, as disclosed herein.

The phrase “azimuthal power distribution devoid of mirror symmetry” in context of describing the second region means that the azimuthal power distribution between 0 and π radians is substantially different to the azimuthal power distribution between π and 2π radians, as disclosed herein.

The phrase “azimuthal thickness distribution” means the one-dimensional thickness distribution of localised lens thickness across arbitrary azimuthal angles measured or defined at an arbitrary radial distance in the non-optical peripheral carrier zone.

The phrase “azimuthally invariant thickness distribution” means that the azimuthal thickness distribution has a substantially uniform thickness distribution, as disclosed herein.

The phrase “azimuthally variant thickness distribution” means that the azimuthal thickness distribution has a substantially non-uniform thickness distribution, as disclosed herein.

The phrase “periodic azimuthal thickness distribution” means that the azimuthal thickness distribution follows a periodic function or repeating pattern.

The phrase “azimuthal thickness distribution with mirror symmetry” means that the azimuthal thickness distribution between 0 and π radians is substantially similar to the azimuthal thickness distribution between π and 2π radians, as disclosed herein.

The phrase “azimuthal thickness distribution devoid of mirror symmetry” means that the azimuthal thickness distribution between 0 and π radians is substantially different to the azimuthal thickness distribution between π and 2π radians, as disclosed herein.

The phrase “Peak-To-Valley (PTV) in azimuthal thickness distribution” means the difference between the thickest and thinnest points along the azimuthal thickness distribution between 0 and 2π radians, defined at an arbitrary radial distance in the non-optical peripheral carrier zone.

The term “ballast” means azimuthally variant thickness distribution devoid of mirror symmetry within the carrier zone for the purpose of maintaining the rotational orientation of a contact lens when placed on an eye.

The term “prism ballast” means a vertical prism used to create a wedge design that will help stabilise the rotation and orientation of a toric contact lens on the eye.

The term “slab-off” means purposeful thinning of the contact lens towards the edge of the inferior and superior periphery of the contact lens in one or more discrete areas to achieve desired contact lens rotational stabilisation.

The term “truncation” refers to an inferior edge of a contact lens that is designed with a nearly straight line for control over rotational stabilisation of a contact lens.

The term “model eye” may mean a schematic, raytracing, or a physical model eye.

The terms “Diopter”, “Dioptre” or “D” as used herein is the unit measure of dioptric power, defined as the reciprocal of the focal distance of a lens or an optical system, in meters, along an optical axis. Usually, the letter “DS” signifies spherical dioptric power, and the letter “DC” signifies cylindrical dioptric power. The terms “regional conoid of Sturm” or “regional interval of Sturm” means the resultant off-axis regional through-focus image profile formed on or about the retina, due to an astigmatic or toric power profile, configured within the second region of the optic zone, represented with regional elliptical blur patterns including the regional sagittal and tangential planes, and a circle of least confusion. The term “back vertex power” means the reciprocal of back vertex focal length over the optical zone, expressed in Dioptres (D).

The terms “SPH” or “Spherical” power means substantially uniform power between all meridians of the optic zone. The terms “CYL” or “Cylinder” power means the difference in back vertex powers between the two principal meridians within the optical zone.

The term “Delta power” means the difference between the maximum and the minimum powers within the pluralities of the meridionally varying power distributions across the optic zone and azimuthally varying power distributions about the optical axis.

The terms “base prescription” or “base prescription for correcting the refractive error” means the standard contact lens prescription required to correct underlying myopia in an individual, with or without astigmatism.

The term “power profile” means the one-dimensional power distribution of localised optical power across the optic zone, either as a function of radial distance at a given azimuthal angle with the optical centre as a reference; or as a function of an azimuthal angle measured at a given radial distance.

The term “power map” means the two-dimensional power distribution across the optical zone diameter in cartesian or polar coordinates.

The term “power profile of the second region” means the distribution of localised optical power as a function of a radial distance and an azimuthal angle measured from the geometrical centre of the second region as a reference. The power profile of the second region may be configured over a circular or an elliptical or an irregular region.

The term “power map of the second region” means the two-dimensional power distribution across of the second region within the optical zone in cartesian or polar coordinates, which may be circular or elliptical or irregular in shape.

The term “astigmatic or toric second region” means a power profile distribution with at least two principal power meridians defined over the second region, wherein the two principal power meridians are configured differently from the base prescription of the optical zone, and the difference between the two principal power meridians determines the magnitude of astigmatism or toric power of the second region.

The terms “partial correction” or “partial correction of the eye” mean a correction for the eye in at least one specific region.

The term “foveal correction” means a correction for the eye in at least the foveal region on the retina of the eye. The term “sub-foveal region” means the region immediately adjacent to the foveal pit of the retina of an eye. The term “parafoveal region” means the region immediately adjacent to the foveal region of the retina of an eye. The term “sub-macular region” means the region within the macular region of the retina of an eye. The term “paramacular region” means the region immediately adjacent to the macular region of the retina of an eye.

The phrase “rotation assisting features” means a periodic azimuthal thickness distribution with a specific periodicity.

The term “specific fit” means that the non-optical peripheral carrier zone comprises an azimuthal thickness distribution about the optical axis, wherein the azimuthal thickness distribution is configured to be substantially invariant to facilitate substantially free on-eye rotation of the contact lens over time. In some examples, the term “specific fit” includes an azimuthal thickness distribution with rotation assisting features. For the avoidance of doubt, the specific fit referred in this invention means that the non-optical peripheral carrier zone is configured with a thickness profile that is substantially free, or devoid, of any ballast, or prism, or any truncation feature found in standard astigmatic or toric contact lenses of the prior art.

### SUMMARY

Certain disclosed embodiments are directed to the configuration of contact lenses for correcting, managing, and treating refractive errors. One embodiment of the proposed invention is aimed to both correct the myopic refractive error and simultaneously provide an optical signal that discourages further eye growth or progression of myopia. The proposed optical device provides a substantially continuously changing regional conoid of partial blur (i.e., optical stop signal) imposed on the peripheral retinal region. This disclosure includes a contact lens comprising a decentred, second region within the optic zone, wherein the second region is characterised with one or more meridionally and azimuthally variant power distributions, wherein at least one of the meridionally and azimuthally variant power distribution is devoid of mirror symmetry, and wherein the contact lens is purposefully configured without a stabilised carrier zone to offer a substantially continuously changing (or temporally and spatially varying) blur signal on the peripheral retina.

One other proposed contact lens embodiment comprises a substantially single vision optic zone with a second region within the optic zone, wherein the second region is characterised with one or more meridionally and azimuthally variant power distributions, wherein at least one of the meridionally and azimuthally variant power distribution is devoid of mirror symmetry; and wherein the single vision portion of the optic zone is used for correcting the myopic refractive error; and wherein the second region provides a regional conoid of partial blur (i.e. optical stop signal) in the peripheral retina that inhibits further eye growth or decelerates the rate of growth. The power distribution of the said second region is configured meridionally and azimuthally varying around its geometric centre. Another feature of the proposed embodiment may include a blending between the second region and the remainder of the optic zone which may be circular or elliptical in shape.

Certain embodiments configured with a decentred second region that is characterised by a meridionally and azimuthally varying power distribution within an otherwise single vision optic zone configured on a rotationally symmetric peripheral non-optical carrier zone may overcome the limitations of the prior art by providing a temporally and spatially varying stop signal. Thus, allowing for minimisation of saturation of treatment effect on myopia progression.

In another embodiment, the present invention is directed to a contact lens for at least one of slowing, retarding, or preventing myopia progression. Another embodiment of the present disclosure is a contact lens comprising a front surface, a back surface, an optic zone, an optical centre, the optical zone including base prescription about the optical centre, a decentred second region with one or more meridionally and azimuthally variant power distributions, wherein at least one of the meridionally and azimuthally variant power distribution is devoid of mirror symmetry, and a non-optical peripheral carrier zone configured symmetrically about the optical zone; wherein the substantial portion of the optical zone is configured at least in part to provide adequate foveal correction; and the second region is configured to provide a regional conoid or interval of partial blur as a directional cue to reduce the rate of myopia progression; and the non-optical peripheral carrier zone is configured to provide a temporally and spatially variant optical stop signal; such that the treatment efficacy to reduce the progression of eye growth remains substantially consistent over time.

Another embodiment of the present disclosure is a contact lens for an eye, the contact lens including an optical zone with an optical centre, a decentred second region with a geometrical centre within the optical zone, and a non-optical peripheral carrier zone about the optical zone, wherein the substantial portion of the optical zone is configured with substantially base prescription providing substantial foveal correction for the eye, and the decentred second region configured with a meridionally and azimuthally varying power distribution, located substantially away from the optical centre, providing at least in part directional cues in the form of a regional conoid of partial blur (i.e. optical stop signal) on the peripheral retina of the eye, and wherein the non-optical peripheral carrier zone is configured substantially without a ballast, or otherwise configured to allow rotation of the contact lens when on the eye, to provide a substantial temporal and spatial variation to the directional cues (i.e. optical stop signal).

In accordance with one of the embodiments, the present disclosure is directed to a contact lens for a myopic eye. The contact lens comprising a front surface, a back surface, an optic axis, an optical zone about the optical axis, the optic zone including a base prescription about the optic axis and a second region with a meridionally and azimuthally varying power profile defined about its geometrical centre, the base prescription configured to correct the refractive error of the eye, and the second region configured to provide directional cues with a regional conoid of partial blur in the peripheral retina; wherein the said contact lens is further configured with a rotationally symmetric peripheral carrier zone to provide a temporally and spatially variant optical stop signal; such that the treatment efficacy to reduce the progression of eye growth remains substantially consistent over time.

The present disclosure is directed towards modifying the incoming light through contact lenses that utilise a stop signal to decelerate the rate of myopia progression. The current disclosure is directed towards a contact lens device configured with a decentred second region within the optical zone, comprising a meridionally and azimuthally varying power profile defined about the geometric centre of the second region, to impose an optical stop signal at the retina of the eye.

Further, the imposed optical stop signal at the retina of the eye is configured to be a temporally (time) and spatially (location) variant. More specifically, this invention disclosure relates to a contact lens that is purposefully configured without any stabilisation in the non-optical peripheral carrier zone that may facilitate a temporally and spatially varying optical stop signal for inhibiting, reducing, or controlling progressive myopic refractive error.

Certain embodiments of the disclosure are directed towards a contact lens for a myopic eye, the contact lens including an optical zone around an optical centre and a non-optical peripheral carrier zone about the optical zone, wherein the optical zone is configured with substantially single vision power providing substantial correction for the eye, and a second region with a meridionally and azimuthally varying power distribution about its geometric centre, the second region configured substantially away from the optical centre, providing at least in part a regional conoid of partial blur producing an optical stop signal for the eye, and wherein the non-optical peripheral carrier zone is configured substantially without a ballast, or otherwise configured to allow rotation of the lens when on the eye, to provide a substantial temporal and spatial variation to the optical stop signal.

The embodiments presented in this disclosure are directed to the ongoing need for enhanced optical designs and contact lenses that may inhibit the progression of myopia while providing reasonable and adequate vision performance to the wearer for a range of activities that the wearer may undertake as a daily routine. Various aspects of the embodiments of the present invention disclosure address such needs of a wearer.

### BRIEF DESCRIPTION OF THE FIGURES

FIG. 1 illustrates the frontal view and a cross-sectional view of a contact lens embodiment. The frontal view further illustrates the optic centre, optic zone, second region within the optic zone, the geometric centre of the second region, a blend zone, and a carrier zone, according to certain embodiments.

FIG. 2A illustrates the frontal view and a cross-sectional view of a contact lens embodiment of the present disclosure. The optic zone of the embodiment substantially comprises of a base prescription and a decentred second region configured with an azimuthally and meridionally varying power profile about its geometric centre. The frontal view further illustrates the optic centre, the optic zone, the blending zone, and the non-optical peripheral carrier zone comprising at least eight (8) cross-sections along arbitrary half-meridians, configured with substantially similar thickness, as disclosed previously in PCT/AU2020/051006.

FIG. 2B illustrates the frontal view and cross-sectional view of another contact lens embodiment of the present disclosure. The optic zone of the embodiment substantially comprises of a base prescription and a decentred second region configured with an azimuthally and meridionally varying power profile about its geometric centre. The frontal view further illustrates the optic centre, the optic zone with the decentred second region, the blending zone, and the non-optical peripheral carrier zone comprising a rotation assisting feature as disclosed herein.

FIG. 3A illustrates the frontal view of another contact lens embodiment of the present disclosure, comprising a decentred second region configured with an azimuthally and meridionally varying power profile about its geometric centre, which illustrates a potential for a substantially free rotation with natural blink action due to the non-optical peripheral carrier zone comprising at least eight (8) cross-sections along arbitrary half-meridians, configured with substantially similar thickness.

FIG. 3B illustrates the frontal view of another contact lens embodiment of the disclosure, comprising a decentred second region configured with an azimuthally and meridionally varying power profile about its geometric centre, which illustrates a rotation assisting contact lens substantially around the optical centre due to the non-optical peripheral carrier zone comprising an azimuthal thickness distribution configured substantially invariant, or configured with a periodic profile with defined periodicity, such that the non-optical peripheral carrier zone predisposes, or assists with, contact lens rotation, according to certain embodiments of the disclosure.

FIG. 4 illustrates a schematic diagram of an on-axis, geometric spot analysis at the retinal plane, when the incoming light, with a visible wavelength (for example, 589 nm) and a vergence of 0 D, is incident on an uncorrected −3 DS myopic model eye.

FIG. 5 illustrates a schematic diagram of an on-axis, geometric spot analysis at the retinal plane, when the incoming light, with a visible wavelength (for example, 589 nm) and a vergence of 0 D, is incident on a −3 DS myopic model eye corrected with one of the contact lens embodiments as previously disclosed in PCT/AU2020/051006.

FIG. 6A illustrates a schematic diagram of an on-axis, through-focus geometric spot analysis at the retinal plane, when the incoming light, with a visible wavelength (589 nm) and a vergence of 0 D, is incident on a −3 DS myopic model eye corrected with a contact lens with a decentred toric second region, as disclosed previously in PCT/AU2020/051006.

FIG. 6B illustrates a schematic diagram of an on-axis, through-focus geometric spot analysis at the retinal plane, when the incoming light, with a visible wavelength (589 nm) and a vergence of 0 D, is incident on a −3 DS myopic model eye corrected with one of the contact lens embodiments with a decentred second region configured with an azimuthally and meridionally varying power distribution, as disclosed herein.

FIG. 6C illustrates a schematic diagram of one of the contact lens embodiments of the current disclosure and a zoomed-in section of the second decentred region of the optical zone, wherein the second region of the optical zone is configured using an azimuthally and meridionally varying power distribution with the geometric centre of the second region as a reference.

FIG. 7A shows the power map of the entire optic zone of one of the contact lenses as disclosed previously in PCT/AU2020/051006, including the power map of the decentred toric second region (Base power: −3 DS, second region power: −3 DS/+1.75 DC).

FIG. 7B illustrates the power distribution (i.e., power map, power as a function of diameter and power as a function of azimuth) of only the decentred second region within the optical zone of a contact lens as disclosed previously in PCT/AU2020/051006 (Base power: −3 DS, second region power: −3 DS/+1.75 DC) configured using standard sphero-cylindrical power distribution.

FIG. 8 illustrates the spatially and temporally varying signal due to contact lens rotation (i.e., 0°, 120° and 240°) depicted as through-focus geometric spot analysis and on-axis point spread functions at the retinal plane when the incoming light is incident on a −3 DS myopic model eye corrected with a contact lens described in FIGS. 7A and 7B.

FIG. 9A shows the power map of the entire optic zone of one of the contact lens embodiments of the current disclosure, including the power map of the decentred second region with an azimuthally and meridionally varying power distribution (Base power: −3 DS, second region (Hem i-Sphere) power −3 DS/1.75 D).

FIG. 9B illustrates the power distribution (i.e., power map, power as a function of diameter and power as a function of azimuth) of only the decentred second region within the optical zone of an exemplary contact lens embodiment of the current disclosure (Base power: −3 DS, second region (Hemi-Sphere) power −3 DS/1.75 D) configured using an azimuthally and meridionally varying power distribution.

FIG. 10 illustrates the spatially and temporally varying signal due to contact lens rotation (i.e., 0°, 120° and 240°) depicted as through-focus geometric spot analysis and on-axis point spread functions at the retinal plane when the incoming light is incident on a −3 DS myopic model eye corrected with a contact lens described in FIGS. 9A and 9B.

FIG. 11A shows the power map of the entire optic zone of one of the contact lens embodiments of the current disclosure, including the power map of the decentred second region with an azimuthally and meridionally varying power distribution (Base power: −1 DS, second region (Cosine-Variant I) power −1 DS/1.25 D).

FIG. 11B illustrates the power distribution (i.e., power map, power as a function of diameter and power as a function of azimuth) of only the decentred second region within the optical zone of an exemplary contact lens embodiment of the current disclosure (Base power: −1 DS, second region (Cosine-Variant I) power −1 DS/1.25 D) configured using an azimuthally and meridionally varying power distribution.

FIG. 12 illustrates the spatially and temporally varying signal due to contact lens rotation (i.e., 0°, 120° and 240°) depicted as through-focus geometric spot analysis and on-axis point spread functions at the retinal plane when the incoming light is incident on a −1 DS myopic model eye corrected with a contact lens described in FIGS. 11A and 11B.

FIG. 13A shows the power map of the entire optic zone of one of the contact lens embodiments of the current disclosure, including the power map of the decentred second region with an azimuthally and meridionally varying power distribution (Base power: −3 DS, second region (Cosine-Variant II) power −3 DS/1.75 D).

FIG. 13B illustrates the power distribution (i.e., power map, power as a function of diameter and power as a function of azimuth) of only the decentred second region within the optical zone of an exemplary contact lens embodiment of the current disclosure (Base power: −3 DS, second region (Cosine-Variant II) power −3 DS/1.75 D) configured using an azimuthally and meridionally varying power distribution.

FIG. 14 illustrates the spatially and temporally varying signal due to contact lens rotation (i.e., 0°, 120° and 240°) depicted as through-focus geometric spot analysis and on-axis point spread functions at the retinal plane when the incoming light is incident on a −3 DS myopic model eye corrected with a contact lens described in FIGS. 13A and 13B.

FIG. 15A shows the power map of the entire optic zone of one of the contact lens embodiments of the current disclosure, including the power map of the decentred second region with an azimuthally, radially and meridionally varying power distribution (Base power: −3 DS, second region (Cosine-Variant III) power −3 DS/1.25 D).

FIG. 15B illustrates the power distribution (i.e., power map, power as a function of diameter and power as a function of azimuth) of only the decentred second region within the optical zone of an exemplary contact lens embodiment of the current disclosure (Base power: −3 DS, second region (Cosine-Variant III) power −3 DS/1.25 D) configured using an azimuthally, radially and meridionally varying power distribution.

FIG. 16 illustrates the spatially and temporally varying signal due to contact lens rotation (i.e., 0°, 120° and 240°) depicted as through-focus geometric spot analysis and on-axis point spread functions at the retinal plane when the incoming light is incident on a −3 DS myopic model eye corrected with a contact lens described in FIGS. 15A and 15B.

FIG. 17 illustrates the thickness distribution of the non-optical peripheral carrier zone as a function of azimuthal angle of the contact lens as described in FIG. 2A with radial cross-sections, along four sample radial distances 4.5 mm, 5.25 mm, 5.75 mm, and 6.25 mm.

FIG. 18 illustrates the thickness distribution of the non-optical peripheral carrier zone as a function of azimuthal angle of the contact lens as described in FIG. 2B with rotation assisting features along a radial distance of 5.5 mm.

FIG. 19 illustrates the thickness distribution of the non-optical peripheral carrier zone as a function of azimuthal angle of another contact lens as described in FIG. 2B with rotation assisting features along a radial distance of 5.5 mm.

### DETAILED DESCRIPTION

Recent designs added to the prior art have some degree of relative positive power related to the prescription power of the lens, usually distributed rotationally symmetric around the optical axis of the contact lens.

Each of these options has its own strengths and weaknesses with respect to retarding the rate of myopia progression in an individual.

Some of the weaknesses are described herein. For example, some problems with the existing optical designs that are based on simultaneous images are that they compromise the quality of vision at various other distances by introducing significant visual disturbances. This side effect is primarily attributed to significant levels of simultaneous defocus, use of significant amounts of spherical aberration, or significant changes in power within the optic zone.

Given the influence of compliance of contact lens wear on the efficacy of such lenses, significant reduction of visual performance may promote poor compliance thus resulting in poorer efficacy. Accordingly, what is needed are optical designs for the correction of myopia and retardation of progression, without causing at least one or more of the shortcomings discussed herein. Other solutions will become apparent as discussed herein.

The efficacy rates of most of the contact lens designs in the prior art are established through randomised control clinical trials. The duration of these clinical trials using the prior art lenses range between 6 months and 3 years and the reported efficacy with the prior art contact lenses range between 25% and 75% when compared to the single vision control lenses.

A simple linear model of emmetropisation suggests that the magnitude of a stop-signal accumulates over time. In other words, the accumulated stop-signal depends on the total magnitude of exposure and not its temporal distribution. However, the inventors have observed from reports of clinical trials of various optical designs that a disproportionally larger percentage of the achieved efficacy or the slowing effect on the rate of progression occurs in the first 6 to 12 months.

After the initial burst of treatment, the efficacy is observed to wane over time. So, in light of the clinical observations, a more faithful model of emmetropisation to line up with the clinical results suggests that there may be a delay before the stop-signal builds, then saturation occurs with time, and perhaps a decay in the effectiveness of the stop-signal.

There is a need in the art for a contact lens that minimises this saturation of the treatment effect by providing a temporally and spatially varying stop-signal to retard the rate of eye growth, for example, myopia progression, without the need of burdening the wearer to switch between contact lenses of differing optical designs during a given period.

Accordingly, there exists a need for optical designs with a mechanism to achieve substantially greater, and/or substantially consistent, efficacy over time in reducing and/or slowing myopia progression without significantly compromising visual performance. In one or more examples, the substantially consistent efficacy over time may be considered to be at least 6, 12, 18, 24, 36, 48 or 60 months.

In this section, the present disclosure will be described in detail with reference to one or more embodiments, some are illustrated and supported by accompanying figures. The examples and embodiments are provided by way of explanation and are not to be construed as limiting to the scope of the disclosure.

The following description is provided in relation to several embodiments that may share common characteristics and features of the disclosure. It is to be understood that one or more features of one embodiment may be combined with one or more features of any other embodiments which may constitute additional embodiments.

The functional and structural information disclosed herein is not to be interpreted as limiting in any way and should be construed merely as a representative basis for teaching a person skilled in the art to employ the disclosed embodiments and variations of those embodiments in various ways.

The sub-titles and relevant subject headings used in the detailed description section have been included only for the ease of reference of the reader and in no way should be used to limit the subject matter found throughout the invention or the claims of the disclosure. The sub-titles and relevant subject headings should not be used in construing the scope of the claims or the claim limitations.

Risk of developing myopia or progressive myopia may be based on one or more of the following factors: genetics, ethnicity, lifestyle, environmental, excessive near work, etc. Certain embodiments of the present disclosure are directed towards a person at risk of developing myopia or progressive myopia.

One or more of the following advantages are found in one or more of the disclosed optical devices, and/or methods of contact lens designs. A contact lens device or method providing a stop signal to retard the rate of eye growth or stop the eye growth or the state of refractive error of the wearer's eye based on a decentred second region within the optic zone configured with a meridionally and azimuthally varying power distribution. Certain embodiments include a contact lens device or method providing a temporally and spatially varying stop signal for increasing the effectivity of managing progressive myopia. A contact lens device or method that is not solely based on either rotationally symmetric positive spherical aberrations or simultaneous defocus primarily configured along the optical axis or optical centre, which suffers from the potential of significant visual performance degradation for the wearer.

The following exemplary embodiment is directed to methods of modifying the incoming light through a contact lens system that offers an optical stop signal at the retinal plane of the corrected eye. This may be achieved by using a decentred second region within the optical zone that is characterised using one or more meridionally and azimuthally variant power distributions, wherein at least one of the meridionally and azimuthally variant power distribution is devoid of mirror symmetry.

In short, the use of a meridionally and azimuthally varying power distribution within the decentred second region of a contact lens may be used to reduce the rate of myopia progression and the reduction of myopia progression may be maintained substantially consistent over time by introducing a spatially and temporally varying stop signal by virtue of a peripheral non-optical symmetric carrier zone.

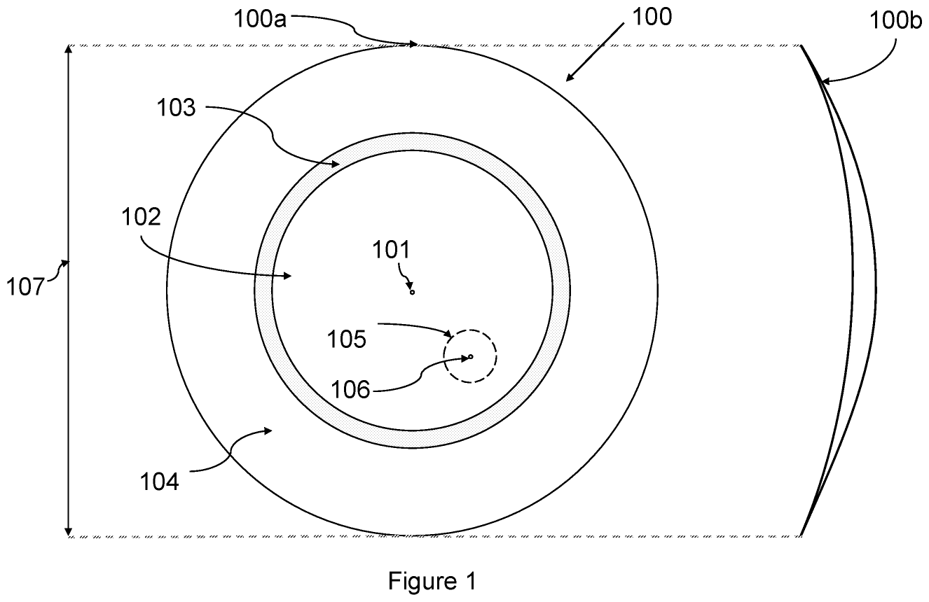

FIG. 1 shows an exemplary contact lens embodiment (100) in the frontal view (100a) and cross-sectional (100b) view, not to scale. The frontal view of the exemplary contact lens embodiment (100) further illustrates an optic centre (101), an optic zone (102), a blend zone (103), a peripheral carrier zone (104), a lens diameter (107) and a decentred second region within the optic zone (105) with a geometric centre (106). In this exemplary contact lens embodiment, the lens diameter is approximately 14 mm, the optic zone is approximately 8 mm in diameter, the blend zone is approximately 0.1 mm wide, the symmetrical carrier zone (104) is approximately 2.75 mm wide and the second region (105) within the optic zone is approximately 1.5 mm×1.5 mm wide. The geometric centre (106) of the decentred second region (105) is 3 mm away from the optic centre (101).

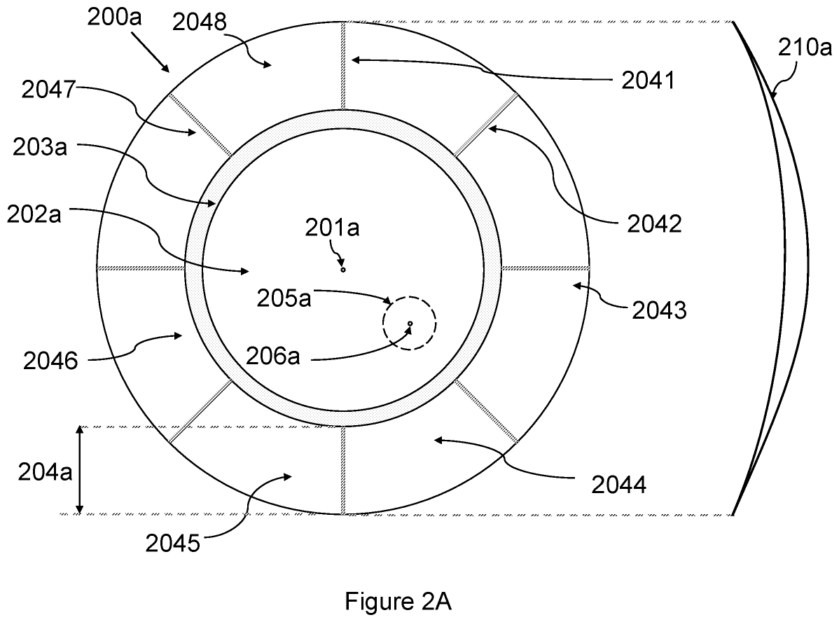

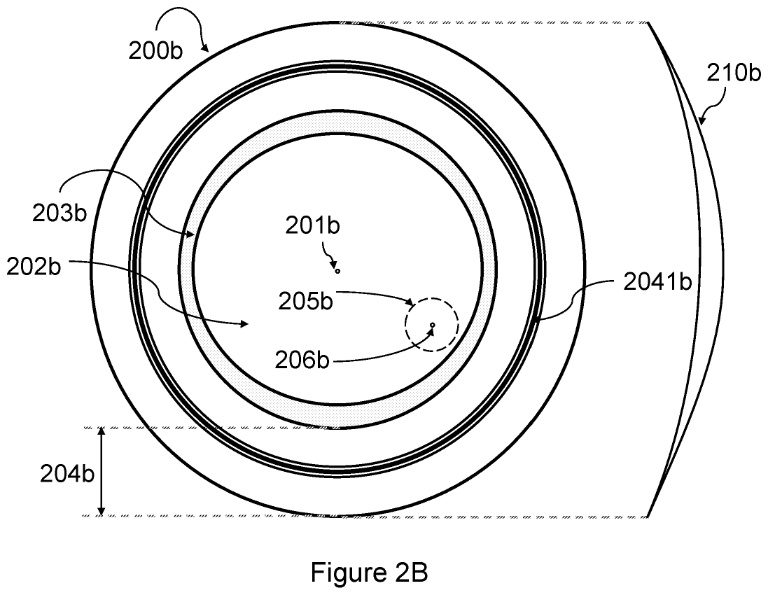

FIG. 2A shows the frontal view and a cross-sectional view of an exemplary contact lens embodiment (200a), not to scale. The frontal view of the exemplary contact lens embodiment further illustrates an optic centre (201a), an optic zone (202a), a blend zone (203a), a peripheral carrier zone (204a) and a second region (205a) within the optic zone (202a) with a geometric centre (206a).

In this exemplary contact lens embodiment, the lens diameter is approximately 14 mm in diameter and the distance correction portion of the optic zone (202a) is rotationally symmetric along the optical axis. The second region (205a) within the optic zone (202a) is circular, i.e., approximately 1.5 mm in diameter. The blend zone (203a) is approximately 0.1 mm in diameter and the symmetrical peripheral carrier zone (204a) is approximately 2.75 mm wide. The radial cross-sections (2041 to 2048) of the symmetrical peripheral carrier zone (204a) have substantially similar thickness profiles, as disclosed previously in PCT/AU2020/051006. The second region (205a) is configured with an azimuthally and meridionally varying power distribution along the geometric centre (206a) providing a stop signal, as disclosed herein.

In this exemplary example, the sphere power of the base prescription of the optic zone (202a) of the contact lens embodiment (200a) has a sphere power of −3 D to correct a −3 D myopic eye and the decentred second region (205a) is configured with an azimuthally and meridionally varying power distribution +1.25 D in delta power to introduce a regional conoid of partial blur at the retina of the eye. In some other examples of the present disclosure, the sphere power of the contact lens to correct and manage myopic eyes may be between −0.5 D to −12 D and the desirable delta power within the decentred second region to introduce the desired regional conoid of partial blur at the retina of the myopic eye may range between 0.75 D to 2.5 D.

The substantial portion of the optic zone, bar the second region, is configured with the base prescription; wherein the base prescription comprises the prescription to correct the foveal refractive error of the contact lens wearer. The power distribution within the decentred second region of the optic zone determines the magnitude, position, location, orientation of the directional cues imposed on or about the peripheral retina.

A preferred on-eye rotation can be achieved by keeping the peripheral thickness profile rotationally symmetric across all half meridians. For example, as disclosed in PCT/AU2020/051006, the radial thickness profiles (for example 204a to 204h) may be configured such that the thickness profiles of any of the other radial cross-sections are substantially identical or within 4%, 6%, 8%, or 10% variance for any given distance from the centre of the lens.

In one example as disclosed in PCT/AU2020/051006, the radial thickness profile 204a is within 5%, 8% or 10% variance of the radial thickness profile of 204e for any given distance from the centre of the lens. In another example, the radial thickness profile 204c is within 4%, 6% or 8% variance of the radial thickness profile of 204g for any given distance from the centre of the lens.

In yet another example as disclosed in PCT/AU2020/051006, the radial thickness profiles, for example, 204a to 204h, may be configured such that the thickness profiles of any of the cross-sections are within 4%, 6%, 8%, or 10% variation of the average of all radial cross sections for any given distance from the centre of the lens.

To ascertain if the manufactured radial thickness profiles, for example, as disclosed in PCT/AU2020/051006 204a to 204h, of the non-optical peripheral carrier zone conform to their nominal profiles, cross-sectional measurements of thickness along the azimuthal direction of the contact lens at a defined radial distance may be desired. In some other examples, the peak thickness measured in one radial cross-section may be compared with the peak thickness measured in another radial cross-section of the non-optical peripheral carrier zone.

In some embodiments, the difference in the peak thicknesses between one or more radial cross-sections may be no greater than 20 μm, 30 μm, 40 μm, 50 μm, or 60 μm. In some embodiments, the difference in the peak thicknesses between one or more perpendicular radial cross-sections may be no greater than 20 μm, 30 μm, 40 μm, 50 μm, or 60 μm.

FIG. 2B shows the frontal view and a cross-sectional view of an exemplary contact lens embodiment (200b), not to scale. The frontal view of the exemplary contact lens embodiment further illustrates an optic centre (201b), an optic zone (202b), a blend zone (203b), a peripheral carrier zone (204b) and a second region (205b) within the optic zone (202b) with a geometric centre (206b).

In this exemplary contact lens embodiment, the lens diameter is approximately 15 mm in diameter and the distance correction portion of the optic zone (202b) is rotationally symmetric along the optical axis. The second region (205b) within the optic zone (202b) is circular, i.e., approximately 1.75 mm in diameter. The blend zone (203b) is approximately 0.15 mm in diameter and the peripheral carrier zone (204b) is approximately 3 mm wide, which is configured with a rotation assisting feature (2041b) comprising of an azimuthal thickness distribution substantially invariant, or with a periodic profile with defined periodicity, such that the non-optical peripheral carrier zone predisposes, or assists with, contact lens rotation, according to certain embodiments of the disclosure. The rotation assisting feature (2041b) may be configured to enhance the desired on-eye rotation about the optical centre of the lens. The second region (205b) is configured with an azimuthally and meridionally varying power distribution along the geometric centre (206b) providing a stop signal, as disclosed herein.

In this exemplary example, the sphere power of the base prescription of the optic zone (202b) of the contact lens embodiment (200b) has a sphere power of −3 D to correct a −3 D myopic eye and the decentred second region (205b) is configured with an azimuthally and meridionally varying power distribution +1.5 D in delta power to introduce a regional conoid of partial blur at the retina of the eye.

The thickness profiles of the manufactured lenses may be measured by using perpendiculars drawn from the tangents at each point on the back surface of the contact lens to the front surface of the contact lens at each point in the non-optical peripheral carrier zone. The measured thickness profiles at each point in the non-optical peripheral carrier zone may also be plotted as a function of azimuthal angles defined at any arbitrary radial distance within the non-optical peripheral carrier zone to provide an azimuthal thickness distribution.

In some examples the azimuthal thickness distribution may be measured or compared at any arbitrary radial distance within the non-optical peripheral carrier zone. In other examples, the azimuthal thickness profiles may be measured or compared by averaging measurements across a range of arbitrary radial distances within the non-optical peripheral carrier zone.

In some examples of variants of FIG. 2B, one or more azimuthal thickness distributions about the optical axis, defined at an arbitrary radial distance in the non-optical peripheral carrier zone, may be configured to be substantially invariant.

The substantial invariance in such instance means a variation in azimuthal thickness distribution that has a peak-to-valley between 5 μm and 50 μm, 10 μm and 40 μm, or between 15 μm and 35 μm.

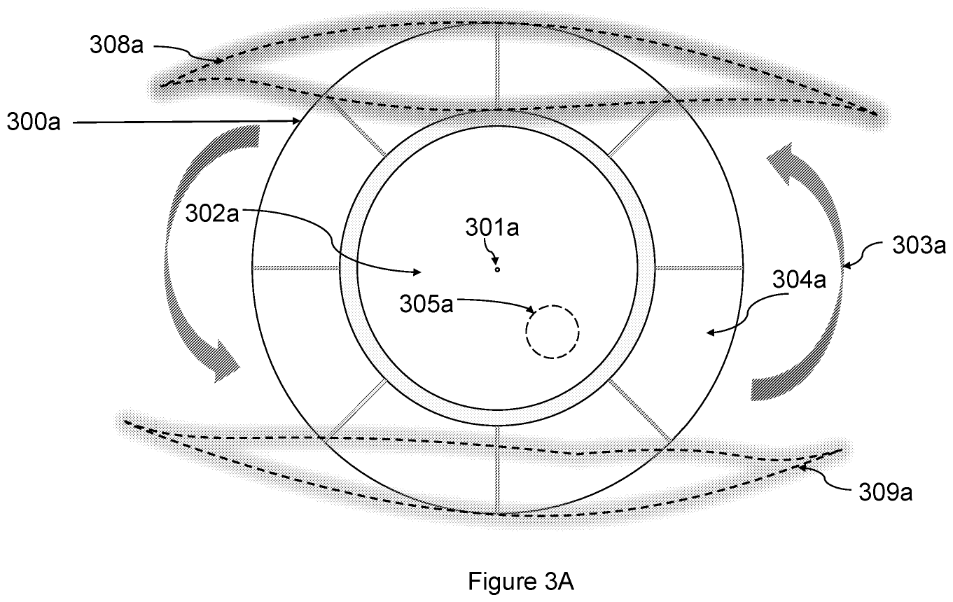

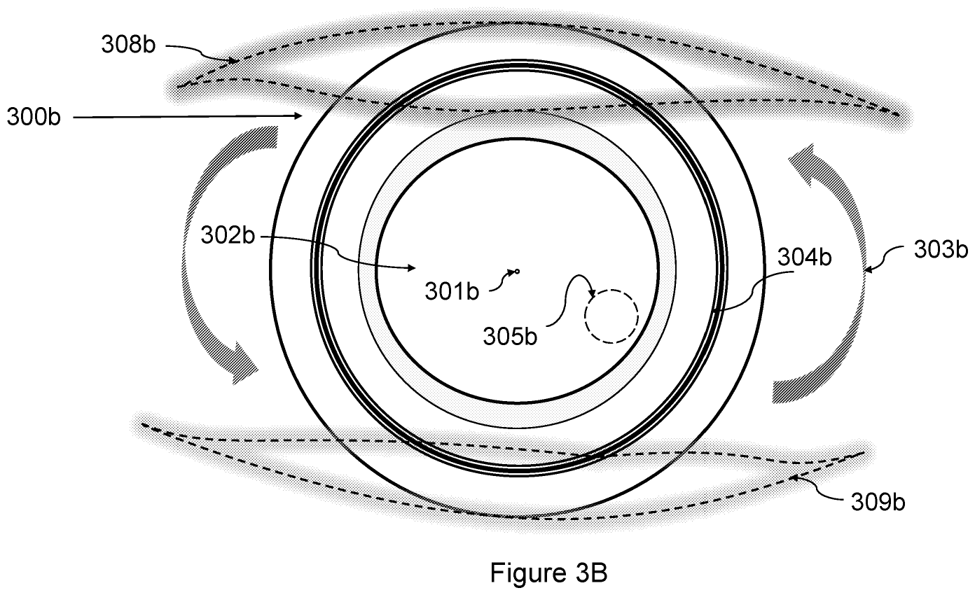

FIG. 3A shows the frontal view of the exemplary contact lens embodiment illustrated in FIG. 2A. This figure attempts to further illustrate the effects of eyelids, lower (309a) and upper (308a) on the orientation (303a) of the contact lens embodiment (300a), particularly the optical zone (302a) which is configured with a decentred second region (305a) with an azimuthally and meridionally varying power distribution.

Due to the natural blink facilitated by the combined action of the upper (308a) and lower (309a) eyelids, the contact lens (300a) may freely rotate on or around about the optical centre (301a). This orientation and location of the regional conoid of partial blur imposed by the decentred second region (305a) within the optical zone (302a) to vary with blink (substantially free rotation and/or decentration), resulting in a temporally and spatially varying stimulus to reduce the rate of progression in a myopic wearer substantially consistent over time.

In some embodiments, for example, as described with reference to FIGS. 2A and 3B, due to the substantially invariant azimuthal thickness distribution within the non-optical peripheral carrier zone as disclosed previously in PCT/AU2020/051006, the contact lens is designed to exhibit substantially free rotation, at least under the influence of the natural blinking action. For example, throughout a day of lens wear, preferably over 6 to 12 hours, the eyelid interaction will dispose the contact lens to be oriented in a large number of different orientations or configurations on the eye. Due to the azimuthally and meridionally varying power distribution configured within the decentred second region of the contact lens embodiment of this disclosure, the directional cues (i.e., regional conoid of blur) to control the rate of eye growth can be configured to vary spatially and temporally.

In some embodiments, the surface parameters of the contact lens embodiment, for example, the back-surface radius and/or asphericity may be tailored to an individual eye such that a desired on-eye rotation of the contact lens may be achieved. For example, the said contact lens may be configured to at least 0.3 mm flatter than the radius of curvature of the flattest meridian of the cornea of the eye to increase the occurrences of on-eye rotation during lens wear.

In certain embodiments, it is understood that the substantially free rotation of contact lens embodiment of the present disclosure is only a desired outcome for one aspect of the invention. However, in instances where the achieved substantially free rotation is less than desired, for example, a rotation of fewer than 20 degrees within 1 hour of lens wear and less than 360 degrees once per day, the invention of the present disclosure is still capable of producing a temporally and spatially varying stop signal by mere random orientation of the lens which is governed by the orientation of the contact lens at the time of insertion.

In some embodiments, for example, as described with reference to FIGS. 2B and 3B, the contact lens is designed to exhibit substantially free rotation, or a predisposition to increase in rotation due to the rotation assisting feature, at least under the influence of the natural blinking action. For example, throughout a day of lens wear, preferably over 6 to 12 hours, the eyelid interaction will dispose the contact lens to be oriented in a large number of different orientations or configurations on the eye. This results in a temporally and spatially varying optical signal or stimulus to reduce the rate of progression in a myopic wearer; wherein the virtue of a spatial and temporally varying stimulus provides the desired effectiveness of managing myopia which remains substantially consistent over time.

Due to the meridionally and azimuthally variant power distribution in the decentred second region within the optic zone configured substantially about the optical centre of the said contact lens, in conjunction with the rotation assisting feature in the non-optical peripheral carrier zone, the resultant regional conoid or interval of partial blur at the retina level of the wearer may be configured to vary spatially and temporally, allowing for minimising the reduction of treatment efficacy as a function of time.

In some embodiments, the surface parameters of the contact lens embodiment, for example, the back-surface radius and/or asphericity may be tailored to an individual eye such that a desired on-eye rotation of the contact lens may be achieved. For example, the said contact lens may be configured to at least 0.1 mm, 0.2 mm, or 0.3 mm flatter than the radius of curvature of the flattest meridian of the cornea of the eye to further increase the occurrences of on-eye rotation during lens wear.

In other examples or variants of FIGS. 2B and 3B, the azimuthal thickness profile of the non-optical peripheral carrier zone may be configured using a sawtooth-like profile to assist with the rotation of the contact lens. For example, the number of teeth contemplated over full 2π radians may be at least 6, at least 8, at least 10, at least 12 or at least 14. The number of teeth is to be no less than 6 to avoid a preferential orientation on eye. In some examples, the amplitude of any individual tooth of the selected array of teeth, the teeth angles and/or direction of the teeth may be selected to provide at least 10%, 20%, 30%, 40% or 50% more rotation compared to the design configured with a substantially invariant azimuthal thickness profile configured within non-optical peripheral carrier zone (i.e., examples or variants of FIGS. 2A and 3A). In some variants of FIGS. 2B and 3B, the azimuthal thickness profile of the non-optical peripheral carrier zone may follow a sinusoidal or a quasi-sinusoidal profile.

For such profiles, the azimuthal thickness profile within the non-optical peripheral carrier zone is not uniform. Furthermore, while contemplating rotation assisting features of the current disclosure, the azimuthal thickness variation may also vary as a function of radial distance within the non-optical peripheral carrier zone. For example, towards the outer edge of the contact lens and towards the front optic zone diameter, the contemplated sawtooth pattern may be reduced to blend in with a uniform edge thickness. In some other embodiments, the contact lens may be designed to have a rotation of fewer than 20 degrees within 1 hour of lens wear and less than 180 degrees once per day. It will be appreciated that this contact lens may be still capable of producing a temporally and spatially varying stop signal by a mere random orientation of the lens which is governed by the orientation of the contact lens at the time of insertion on any given day.

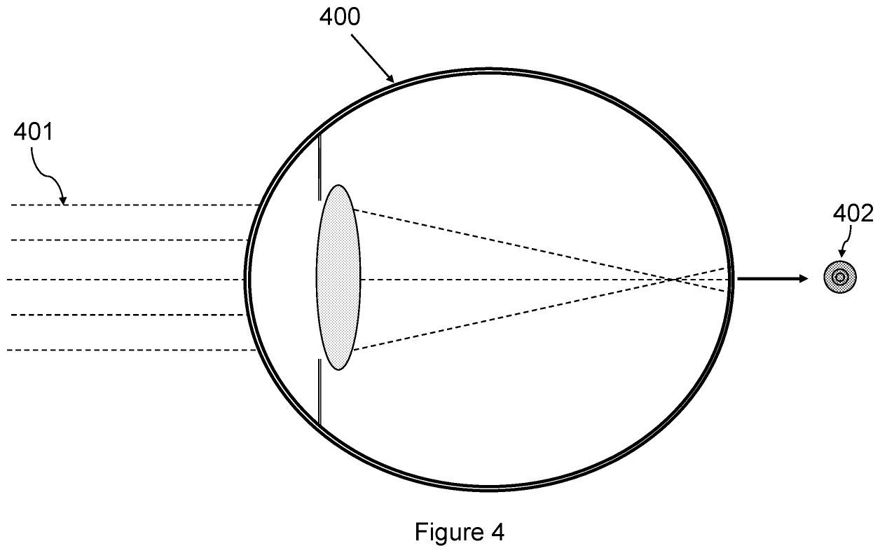

FIG. 4 shows an uncorrected −3 D myopic model eye (400). When the incoming light (401) of a visible wavelength (for example, 555 nm) of a vergence 0 D, is incident on the uncorrected myopic eye, the resultant image on the retina has a symmetrical blur (402) caused by defocus. This schematic diagram represents an on-axis, geometric spot analysis at the retinal plane.

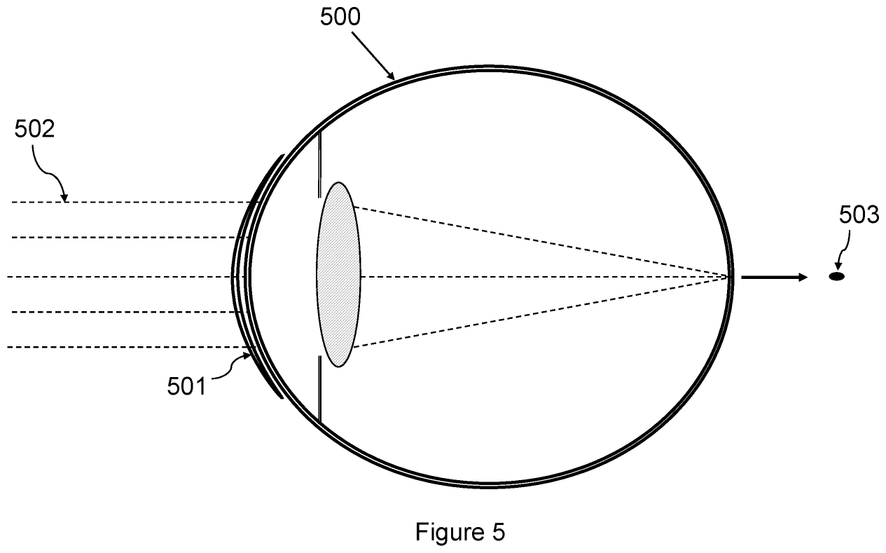

FIG. 5 shows the schematic diagram of an on-axis, geometric spot analysis at the retinal plane when the −3 D myopic model eye (500) of FIG. 4 is corrected with a single vision spherical contact lens comprising a decentred second region configured with an astigmatic power profile, as disclosed previously in PCT/AU2020/051006 (501). Here in this example, when the incoming light (502) of a visible wavelength (for example, 555 nm) of a vergence 0 D, is incident on the corrected myopic eye, the resultant image on the retina has a symmetrical sharp focal point from the single vision portion of the lens and an elliptical blur pattern (503) from the decentred astigmatic second region.

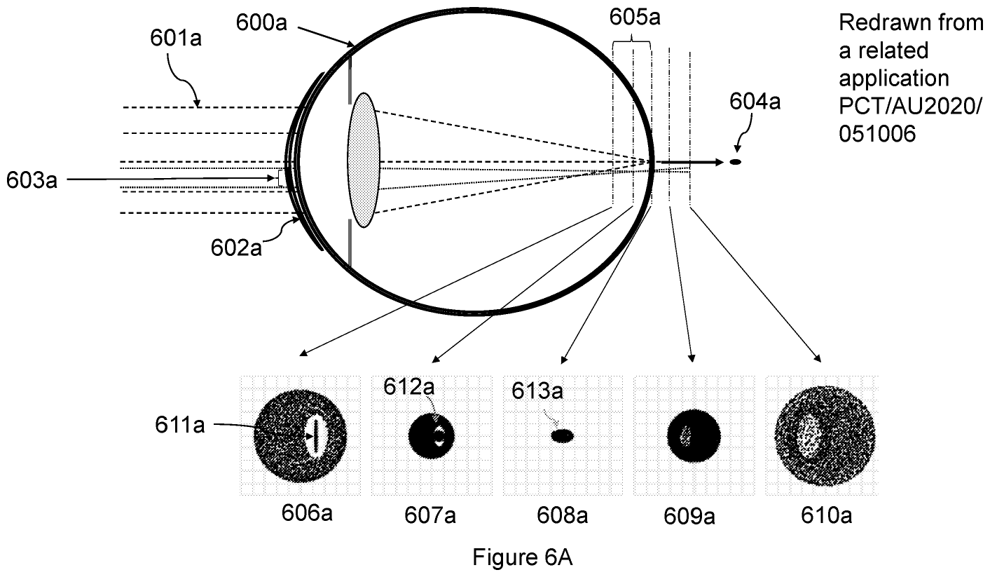

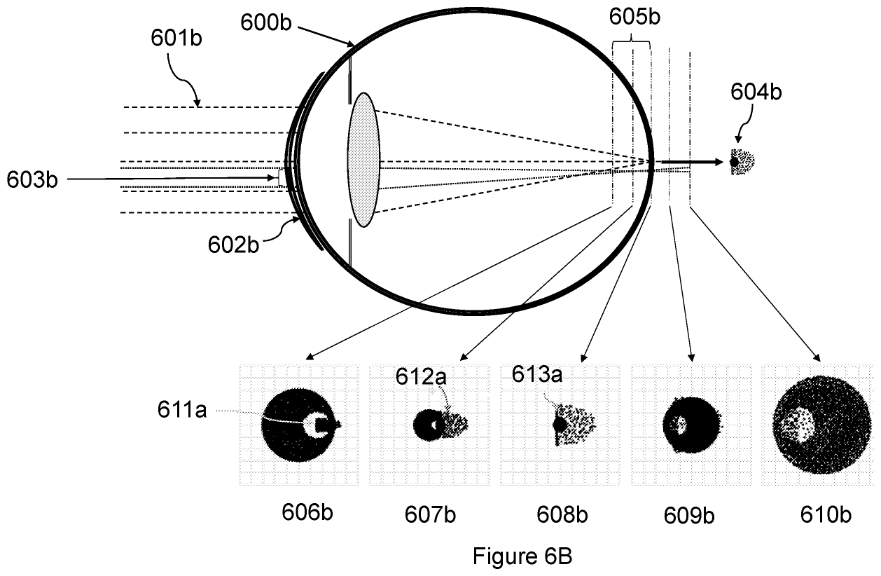

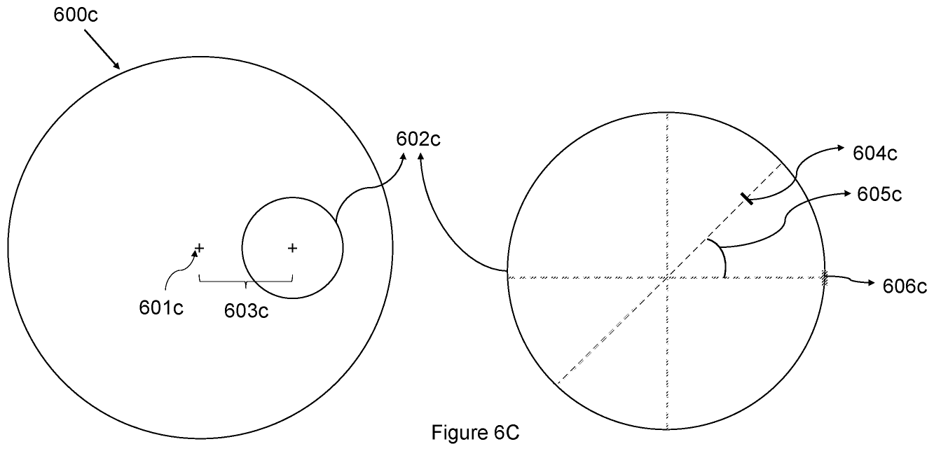

FIG. 6A shows the schematic diagram of an on-axis, through-focus, geometric spot analysis about the retinal plane when the −3 D myopic model eye (600a) of FIG. 4 is corrected with a contact lens (602a) configured with astigmatic power distribution within the decentred second region (603a) of the optic zone of the contact lens (602a), as disclosed previously in PCT/AU2020/051006. In this example, when the incoming light (601a) of a visible wavelength (for example, 589 nm) of a vergence 0 D, is incident on the myopic eye (600a) through the contact lens (602a), the incoming light results in a through-focus image profile, encompassing a series of geometric spot distributions depicted from 606a to 610a. The astigmatic, or toric, power distribution configured within the decentred second region (603a) of the optical zone (602a) results in a regional conoid or an interval of Sturm (606a) within the through-focus image profile (606a to 608a), formed substantially in front of the retina.

As can be seen in FIG. 6A, the regional conoid or interval of Sturm (605a) about the retinal plane formed by the decentred second region (603a) within the optic zone of the contact lens (602a) can be observed by inspecting the through-focus spot diagrams (606a, 607a and 608a). Each of the three (3) spot diagrams have a diffuse spread of rays or light energy over about 200 μm central region of the retina (606a, 607a and 608a). Within each of the through-focus spot diagrams, there is at least one distinct region formed with minimal spread of rays or light energy, can be seen as ellipses, that contain the conoid or interval of Sturm (605a). The size of the three through-focus spot diagrams encompassing each of the tangential plane (611a), the circle of least confusion (612a) and the sagittal blur pattern (613a) are progressively smaller as they approach the retina.

FIG. 6B shows the schematic diagram of an on-axis, through-focus, geometric spot analysis about the retinal plane when the −3 D myopic model eye (600b) of FIG. 4 is corrected with a contact lens (602b) configured with an azimuthally and meridionally varying power distribution within the decentred second region (603b) of the optic zone of the exemplary embodiment (602b). In this example, when the incoming light (601b) of a visible wavelength (for example, 589 nm) of a vergence 0 D, is incident on the myopic eye (600b) through the exemplary contact lens embodiment (602b), the incoming light results in a through-focus image profile, encompassing a series of geometric spot distributions depicted from 606b to 610b. The azimuthally and meridionally varying power distribution configured within the decentred second region (603b) of the optical zone (602b) results in a regional conoid or an interval of partial blur (606b) within the through-focus image profile (606b to 608b), formed substantially in front of the retina.

As can be seen in FIG. 6B, the regional conoid or interval of partial blur (605b) about the retinal plane formed by the decentred second region (603b) within the optic zone of the exemplary contact lens (602b) can be observed by inspecting the through-focus spot diagrams (606b, 607b and 608b). Each of the three (3) spot diagrams have a diffuse spread of rays or light energy over about 200 μm central region of the retina (606b, 607b and 608b). Within each of the through-focus spot diagrams, there is at least one distinct region formed with minimal spread of rays or light energy, can be seen as irregular blur patterns, that contain the conoid or interval of partial blur (605b). The size of the three through-focus spot diagrams encompassing each of the tangential plane (611b), the circle of least confusion (612b) and the sagittal blur pattern (613b) are progressively smaller as they approach the retina.

The through-focus image profile in front of the retina (606b to 608b) contains the tangential irregular blur pattern (611b), a circle of least confusion (612b) and the sagittal irregular blur pattern (613ba), as depicted within the sub-region of the series of geometric spot distributions formed in the parafoveal or paramacular region. The resultant image (604b) on the foveal region is depicted as a minimal irregular blur pattern, as seen in its zoomed-in version (613b). As can be seen, the section of the through-focus image profile formed behind the retina (609b and 610b) are out of focus.

In this example, the contact lens embodiment (602b) with the decentred second region (603b) within the optical zone, is configured in a way that the regional conoid or the interval of partial blur (605b) is on or in front of the retinal plane. However, in other exemplary embodiments, the regional interval of partial blur may be configured in a way that it is entirely in front of the retina, on or about the retinal plane or entirely behind the retina. In some embodiments, the depth of the regional conoid or interval of partial blur can be at least 0.3, 0.4, 0.5, 0.6, or 0.75 mm.

In other embodiments, the regional conoid or interval of partial blur may be configured to be at least 1 D, 1.25 D, 1.5 D, 1.75 D or at least 2 D. In some embodiments, the positioning of the regional conoid or interval of partial blur may be configured to be in front, or behind the retina. Further, due to the rotational assisting features and/or the substantially invariant azimuthal thickness distribution configured in the peripheral carrier zone, the orientation and location of the regional conoid of partial blur (stop signal) imposed on the retina varies with natural blink action substantially over time, leading to a temporally and spatially varying stop signal due to the rotation and decentration of the contact lens.

In some examples, the said regional conoid of partial blur is configured further away from the sub-foveal, foveal, sub-macular, macular, or para-macular regions. In some examples, the said regional conoid of partial blur may be configured at a wider field angle on the retina, for example at least 5 degrees, at least 10 degrees, at least 20 degrees, or at least 30 degrees.

Specific structural and functional details disclosed in these figures and examples are not to be interpreted as limiting, but merely as a representative basis for teaching a person skilled in the art to employ the disclosed embodiments in numerous other variations.

A schematic model eye (Table 1) was chosen for illustrative purposes in FIGS. 4 to 6B. However, in other exemplary embodiments, schematic raytracing model eyes like Liou-Brennan, Escudero-Navarro and others may be used instead of the above simple model eye. One may also alter the parameters of the cornea, lens, retina, ocular media, or combinations thereof, to aid further simulation of the embodiments disclosed herein.

The examples provided herein have used a −3 D myopic model eye to disclose the present invention, however, the same disclosure can be extended to other degrees of myopia, for example, −1 D, −2 D, −5 D or −6 D. Further, it is understood that a person skilled in the art can draw extensions to eyes with varying degrees of myopia in conjunction with astigmatism up to 1 DC.

In the example embodiments, reference was made to a specific wavelength of 555 nm, however, it is understood that a person skilled in the art can draw extension to other visible wavelengths between 420 nm and 760 nm. Certain embodiments of the present disclosure are directed to contact lenses that may provide a temporally and spatially varying, in other words varying substantially in retinal location over time, stop signal to the progressing myopic eye, achieved with the help of the natural on-eye rotation and decentration of the contact lens occurring due to the natural blink action. This temporally and spatially varying stop signal may minimise the implicit saturation effects of efficacy that are observed in the prior art.

Certain embodiments of the present disclosure are directed to contact lenses that may provide a spatially and temporally varying stop signal to the progressing myopic eye no matter in which orientation the contact lens is worn, or inserted, by the wearer. In some embodiments of the present disclosure, the stop signal in the decentred second region of the optic zone may be configured using an azimuthally and meridionally varying power distribution along the geometrical centre of the said second region.

FIG. 6C illustrates a schematic diagram of a zoomed-in section of the second region (602cb) within the optical zone of one of the contact lens embodiments (600c) defined with an azimuthally and meridionally varying power distribution disclosed herein. The distance between the optic centre (601c) and the geometric centre of the second region (602c) is the amount of decentration (603c), as referred to within the current disclosure. Further, the azimuthally and meridionally varying power distribution of the second region can be described with the following variables: the radial coordinate (604c), the azimuthal angle Theta (θ) (605c) and the semi-diameter (606c).

Table 1 differentiates the Designs I and II of the present disclosure from the design of the second astigmatic region within the optic zone of the contact lens as previously disclosed in PCT/AU2020/051006. The abbreviations VAR and SYM in Table 1 stand for variance and symmetry, respectively. As can be seen from the table, the two differentiating elements that isolate the disclosed designs from the previously disclosed design largely rely on the meridional and azimuthal variance of power profiles of the second region within the optic zone. Whereas the astigmatic or toric second region within the optic zone of the previously disclosed contact lens (PCT/AU2020/051006) is characterised by an azimuthally variant but meridionally invariant power profile, the designs of the second region of the current disclosure are all configured with one or more meridionally and azimuthally variant power distributions, wherein at least one of the meridionally and azimuthally variant power distribution is devoid of mirror symmetry. The examples provided in this specification have used model eyes with −1 DS and −3 DS of myopia to disclose the present invention. The same disclosure can be extended to other degrees of myopia, for example, −2 DS, −4 DS, or −6 DS of myopia. In the example embodiments, reference was made to a specific monochromatic wavelength of 589 nm. In other examples, the lens designer may draw an extension to other visible wavelengths between 420 nm and 760 nm.

TABLE 1
Power description of the second region
for different contact lens designs.

| | Second region | | | | |
|---|---|---|---|---|---|
| | Power distribution | | | | |
| | Meridional | | Radial | Azimuthal | |
| Lens Types | VAR | SYM | VAR | VAR | SYM |
| Design disclosed in | NO | YES | NO | YES | YES |
| PCT/AU2020/051006 | | | | | |
| Disclosed Designs I | YES | NO | YES/NO | YES | NO |
| Disclosed Designs II | YES | NO | YES/NO | YES | NO |

Certain embodiments of the present disclosure are directed to contact lenses that may provide a temporally and spatially varying, in other words varying substantially in a retinal location, substantially over time, stop signal to the progressing myopic eye, achieved with the help of the natural on-eye rotation of the contact lens occurring due to the natural blink action. This temporally and spatially varying stop-signal may minimise the implicit saturation and/or fading effects of efficacy that are observed with the lenses of prior art.

Certain embodiments of the present disclosure are directed to contact lenses that may provide a spatially and temporally variant stop signal to the progressing myopic eye no matter in which orientation the contact lens is worn, or inserted, by the wearer. In some embodiments of the present disclosure, the stop signal within the second region of the optic zone of the contact lens may be configured using a meridionally and azimuthally variant power distribution. The meridionally and azimuthally variant power distribution may be further configured using a radial invariant power distribution about the geometric centre of the second region of the contact lens.

In some other embodiments, the meridionally and azimuthally variant power distribution may be configured using a substantially radially invariant power distribution. In certain embodiments of the present disclosure, the meridionally and azimuthally variant power distribution within the second region of the optic zone of the contact lens may be configured using a radially invariant, meridionally variant profile across the entire second region of the optic zone and an azimuthally variant profile across a selected substantially partial area of the second region of the optic zone on the contact lens while the rest of the area is configured with an azimuthally invariant power distribution.

In some embodiments the contemplated or selected partial area of the azimuthally variant profile may be 25%, 30%, 35%, 40%, 45%, or 50% of the total area of the second region of the optic zone on the contact lens. In some other embodiments the contemplated or selected partial area of the azimuthally variant profile may be between 20% and 30%, 30% and 50%, 15% and 45% of the total area of the second region of the optic zone on the contact lens.

In certain embodiments of the present disclosure, the meridionally and azimuthally variant power distribution within the second region of the optic zone of the contact lens may be configured using a radially variant power distribution across substantially the entire second region of the optic zone; wherein the variance in the radial dimension is configured such that the power increases or decreases from the geometric centre of the second region of the optic zone to the margin of the second region of the optical zone and the variance in the azimuthal dimension is configured such that the power decreases from 0 to 2π radians.

In some contact lens embodiments of the present disclosure, the decrease in power distribution along the radial direction may be described using linear, curvilinear, or quadratic functions. In certain other embodiments of the present disclosure, the decrease in power distribution along the radial direction within the second region of the optic zone may be different for different azimuthal positions within the second region of the optic zone.

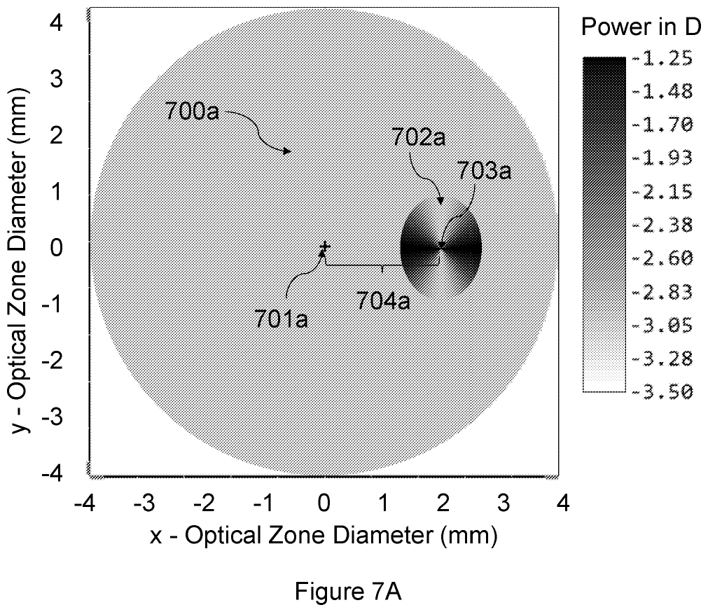

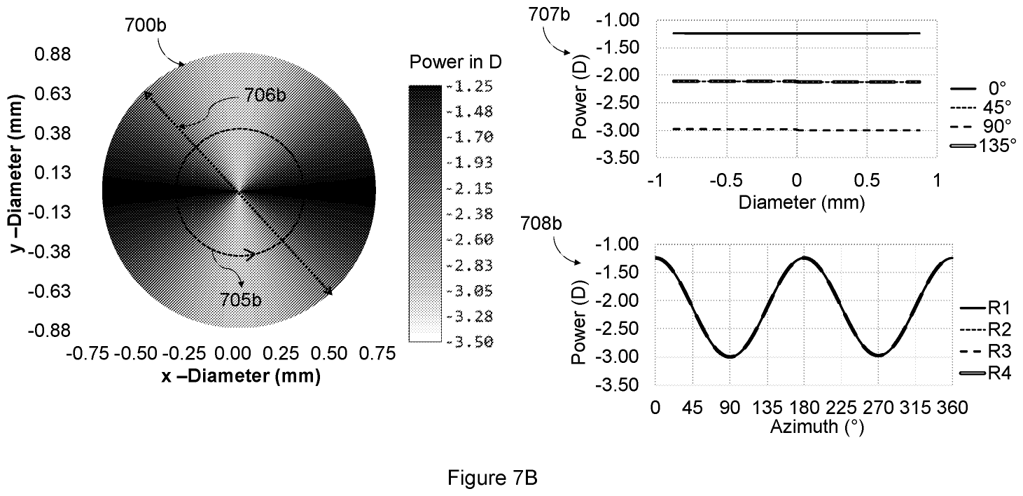

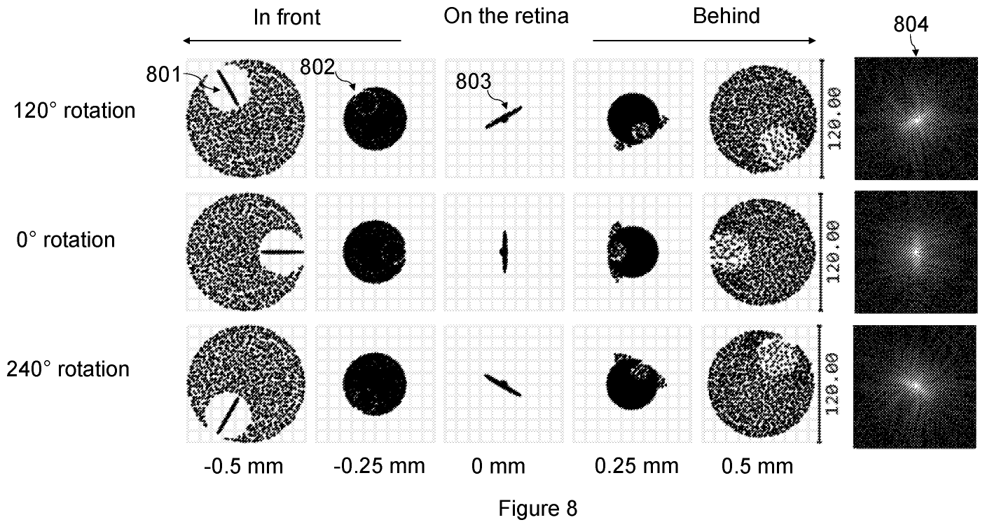

In other embodiments, the decrease in power distribution along the azimuthal direction within the second region of the optic zone may follow a cosine distribution with reduced frequency, for example in some embodiments it may be one-sixth (⅙), one-fifth (⅕), one-fourth (¼), one-third (⅓), or half (½), of the normal frequency contemplated in a toric or astigmatic lens, as disclosed previously in PCT/AU2020/051006. The term normal frequency contemplated in a toric or an astigmatic power profile of the second region within the optic zone can be observed or seen in FIGS. 7A, 7B and 8.

In other embodiments of the present disclosure, the decrease in power distribution along the azimuthal direction may be different for different radial positions within the second region of the optic zone. In yet another embodiment of the present disclosure, the decrease in power distribution along the azimuthal direction may be the same across substantially all radial positions within the second region of the optic zone.

In certain embodiments, the meridionally and azimuthally variant power distribution within the second region of the optic zone may be configured such that the power distribution is the sum of, the base sphere prescription, and product of the radial or meridional and azimuthal power distribution functions. In some embodiments, the power distribution function within the second region of the optic zone may be radially invariant but meridionally and azimuthally variant. In some embodiments, the power distribution function within the second region of the optic zone is meridionally and azimuthally variant and further configured radially variant. In some other embodiments, the power distribution function within the second region of the optic zone of the contact lens may be radially invariant and azimuthally invariant for substantially 10%, 20%, 30%, 40%, or 50% of the area of the second region of the optical zone of the contact lens and azimuthally variant over the remainder area of second region of the optic zone.

In certain contact lens embodiments, a substantial portion of the optical zone provides a substantial foveal correction for a myopic eye, and the decentred second region within the optical zone provides at least in part a regional conoid of partial blur serving as a directional cue to reduce the rate of myopia progression; the contact lens is further configured to provide a temporally and spatially varying stop signal to reduce the rate of myopia progression substantially consistent over time. In certain other embodiments, the optical stop signals configured using a decentred second region in the optic zone, provides a regional conoid or interval of partial blur on or about the peripheral retina; wherein the depth of the said regional conoid or interval of partial blur is at least 0.5 D, 0.75 D, 1 D, 1.25 D, 1.5 D, 1.75 D, or 2 D.

In certain other embodiments, the optical stop signals configured using a decentred second region in the optic zone, which is rotationally asymmetric about the optical axis or optical centre, provides a regional conoid or interval of partial blur on or about the peripheral retina; wherein the depth of the said regional conoid or interval of partial blur ranges between 0.5 D and 1.25 D, 0.75 D and 1.25 D, 0.5 D and 1.5 D, 1 D and 1.75 D or 1.5 D and 2 D.

In certain other embodiments, the second region may be defined with an azimuthally and meridionally varying power distribution defined about the geometric centre of the second region; wherein the azimuthally and meridionally varying power distribution of the said second region is different from the base prescription of the contact lens.

In certain other embodiments, the optical stop signals configured using a decentred second region in the optic zone, which is rotationally asymmetric about the optical axis or optical centre, provides a regional conoid or interval of partial blur on or about the peripheral retina; wherein the depth of the said regional conoid or interval of partial blur ranges between −0.5 DC and +1.25 DC, −0.75 DC and +1.25 DC, −0.5 DC and +1.5 DC, −0.75 DC and +0.75 DC or −1 DC and +1 DC.

In other embodiments of the present disclosure, the stop signal configured through the second region within the optical zone may solely use azimuthally and meridionally varying power distributions.

Schematic model eyes were used for simulation of the optical performance results of the exemplary embodiments of the current disclosure (FIGS. 7 to 16). The prescription parameters of the schematic model eye used for optical modeling and simulation of the performance are tabulated in Table 2. The prescription offers a −3 D myopic eye defined for a monochromatic wavelength of 589 nm.

TABLE 3
Prescription of a schematic model eye
that offers a −3 D myopic model eye.

| | | | | Semi | |
|---|---|---|---|---|---|
| | Radius | Thickness | Refractive | Diameter | Conic |
| Comments | (mm) | (mm) | Index | (mm) | Constant |
| | Infinity | Infinity | | 0.00 | 0.000 |
| Start | Infinity | 5.000 | | 4.00 | 0.000 |
| Anterior | 7.75 | 0.550 | 1.376 | 5.75 | −0.250 |
| Cornea | | | | | |
| Posterior | 6.40 | 3.000 | 1.334 | 5.50 | −0.400 |
| Cornea | | | | | |
| Pupil | Infinity | 0.450 | 1.334 | 5.00 | 0.000 |
| Anterior | 10.80 | 3.800 | 1.423 | 4.50 | −4.798 |
| Lens | | | | | |
| Posterior | −6.25 | 17.775 | 1.334 | 4.50 | −4.101 |
| Lens | | | | | |
| Retina | −12.00 | 0.000 | | 10.00 | 0.000 |

The prescription described in Table 2 should not be construed as an imperative method to demonstrate the effect of the contemplated exemplary embodiment.

It is just one of many methods that may be used by the person skilled in the art for optical simulation purposes. To demonstrate the effects of other embodiments, other schematic model eyes like Atchison, Escudero-Navarro, Liou-Brennan, Polans, Goncharov-Dainty may be used instead of the above schematic model eye.

A person skilled in the art may also alter the parameters of the individual parameters of the model eye; for example, the cornea, lens, retina, media, or combinations thereof, to aid a better simulation of the effect is described. The parameters of the model contact lens exemplary embodiment only simulate the optic zone for the performance effects.

To demonstrate the performance variation as a function of time, the tilt functions on the surface have been used to mimic the rotation that would occur physiologically in vivo. For the simulations of the optical performance results the exemplary embodiments were rotated at 0°, 120° and 240° for the point spread functions and the through-focus geometric spot analysis.

FIG. 7A illustrates the two-dimensional power map (in D) of a contact lens as previously disclosed in PCT/AU2020/051006 across an 8 mm optic zone diameter (700a). As disclosed in PCT/AU2020/051006, the optic zone (700a) of the contact lens is meant to be grafted onto a substantially rotationally symmetric non-optical peripheral carrier zone. The contact lens has a sphere power of −3 DS in the optic zone (700a) to correct the −3 DS myopic eye and a toric or an astigmatic power distribution in the second region (702a) within the optic zone (700a) defined with two principal power meridians (not to scale).

In FIG. 7A, one principal power meridian (−3 DS) of the second region is aligned perpendicular to the optical centre (701a) of the optical zone (700a) and the second principal power meridian (−1.25 DS) of the second region is configured to be in parallel to the optical centre (701a) of the optic zone (700a).

The difference between the principal power meridians (+1.25 DC) is the astigmatic power of the second region (702a) used to impose the optical stop signal as disclosed previously in PCT/AU2020/051006. The second region (702a) within the optical zone (700a) has a diameter of 1.5 mm×1.75 mm and its geometrical centre (703a) is decentred by 1.25 mm from the optical centre (701a) of the optic zone (700a).

The blending width is 0.1 mm. However, this contact lens example is not meant to be construed as limiting the scope of the disclosure.

FIG. 7B illustrates the power map distribution (700b) of the second region (702a) within the optical zone (700a) of one of the contact lenses as previously disclosed in PCT/AU2020/051006, and the power changes along one azimuth (705b) and along one meridian (706b) within the power map. FIG. 7B also shows the corresponding power profiles as a function of second region diameter for four representative sample meridians 0°, 45°, 90° and 135° (707b), and its corresponding power profiles as a function of azimuth for four representative sample radial positions R1, R2, R3 and R4 (708b) with radial distances of 0.15, 0.3, 0.45 and 0.6 mm, respectively.

The second region (702a) of the optic zone (700a) of the contact lens is configured using a standard sphero-cylindrical power distribution function, wherein one principal meridian (vertical meridian, 90°) has a power of approximately −3.00 D, the other principal meridian (horizontal meridian, 0°) has a power of approximately −1.25 D and the oblique meridians 45° and 135° have a power of approximately −2.12 D. The difference between the two principal meridians is the cylinder power, which in this exemplary embodiment is 1.75 DC. The power distribution of the toric or astigmatic second region is symmetrical as it has a radially and meridionally invariant power distribution that follows a cosine function with normal frequency, which results in an azimuthally varying power distribution with two axes of mirror-symmetry (i.e., two cosine cycles over 360°). The term normal frequency contemplated in a second region with a toric or an astigmatic power map can be observed or seen in FIG. 7B.

FIG. 8 illustrates the through-focus geometric spot analysis and the corresponding on-axis point spread functions (804) when the −3 D myopic model eye of Table 1 is corrected with the contact lens described in FIGS. 7A and 7B in three configurations. In this example, the through-focus geometric spot analysis was performed at the following locations: −0.5 mm and −0.25 mm in front of the retina, on the retina and +0.25 mm and +0.5 mm behind the retina.

The on-eye rotation of the contact lens embodiment over time results in three configurations that provide a temporally and spatially varying signal on the retina.

In this example, the three configurations represent the test case wherein the principal power meridian of the lens is located at 0°, 120° and 240° azimuthal positions over time with contact lens rotation. In this example, for each contact lens configuration, depicted as rows, the astigmatic or toric power distribution configured within the second region of the optical zone results in a regional conoid or an interval of Sturm (801, 802, 803) that is formed substantially in front of the retina within the through-focus image profile, in the parafoveal or paramacular region.

As can be seen in FIG. 8, the regional conoid or interval of Sturm about the retinal plane formed by the decentred second region within the optic zone of FIG. 7B can be observed by inspecting the through-focus spot diagram which has a diffuse spread of rays or light energy over about 120 μm central region of the retina. Within the through-focus spot diagram, there is a distinct region formed with minimal spread of rays or light energy, that contains the elliptical blur pattern of the conoid or interval of Sturm (801 and 803). The orientation of the elliptical blur pattern (801 and 803) and the corresponding point spread function (804) change with the orientation of the contact lens on the eye, providing temporally and spatially varying directional cues for the eye, as previously disclosed in PCT/AU2020/051006.

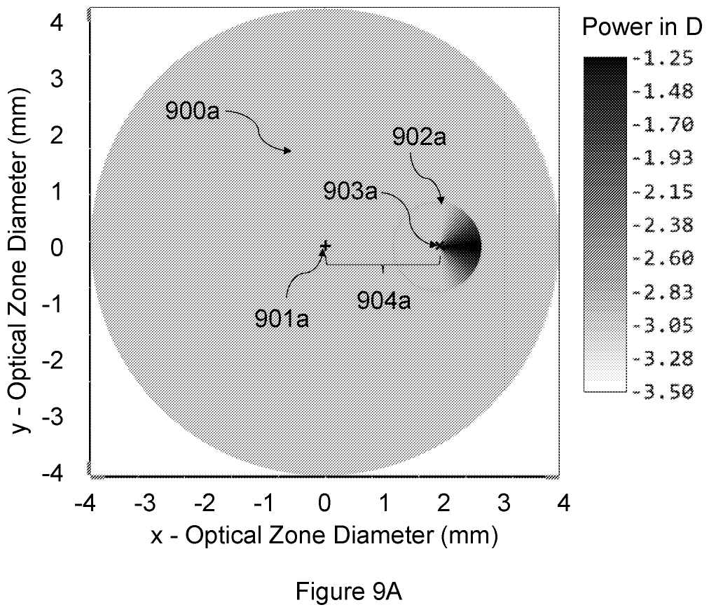

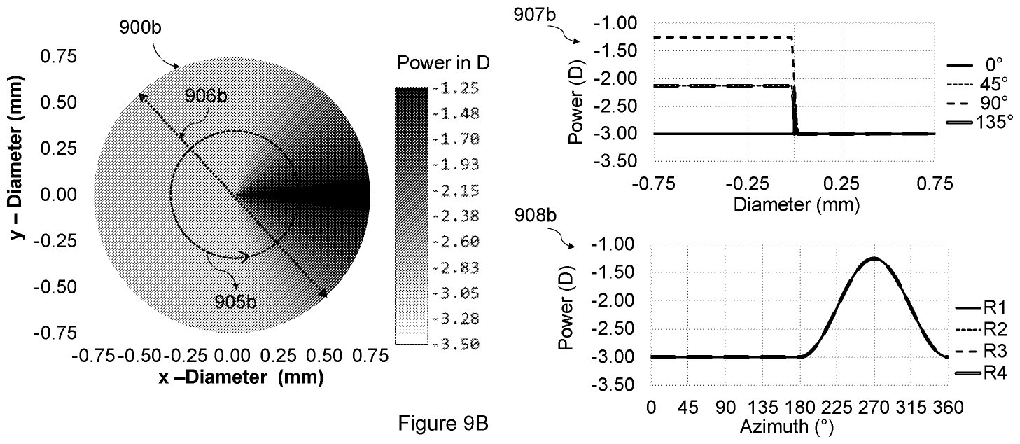

FIG. 9A illustrates the two-dimensional power map (in D) of a contact lens embodiment of this disclosure across an 8 mm optic zone diameter (900a). The optic zone (900a) of the contact lens is meant to be grafted onto a non-optical peripheral carrier zone with rotation assisting features. The contact lens has a sphere power of −3 DS in the optic zone (900a) to correct the −3 DS myopic eye and an azimuthally and meridionally varying power distribution in the second region (902a) within the optic zone (900a). The second region (902a) within the optical zone (900a) has a diameter of 1.5 mm and its geometrical centre (903a) is decentred by 1.25 mm from the optical centre (901a) of the optic zone (900a). The blending width is 0.1 mm. However, this contact lens example is not meant to be construed as limiting the scope of the disclosure.

FIG. 9B illustrates the power map distribution (900b) of the second region (902a) comprising an azimuthally and meridionally varying power distribution (Hemi-Sphere Region), and the power changes along one azimuth (905b) and along one meridian (906b) within the power map. FIG. 9B also shows the corresponding power profiles as a function of second region diameter for four representative sample meridians 0°, 45°, 90° and 135° (907b), and its corresponding power profiles as a function of azimuth for four representative sample radial positions R1, R2, R3 and R4 (908b) with radial distances of 0.15, 0.3, 0.45 and 0.6 mm, respectively.

The second region (902a) of the optic zone (900a) of the contact lens is configured with a substantially radially invariant, meridionally and azimuthally variant, power distribution (power: −3 DS/+1.75 D, Hem i-Sphere Region), wherein the flattest half-meridian has a power of approximately −1.25 DS, the steepest half-meridian has a power of approximately −3.00 DS and the oblique meridians 45° and 135° have a power of approximately −2.12 DS. The difference between the flattest and the steepest half-meridian is the delta power, which in this exemplary embodiment is 1.75 D.

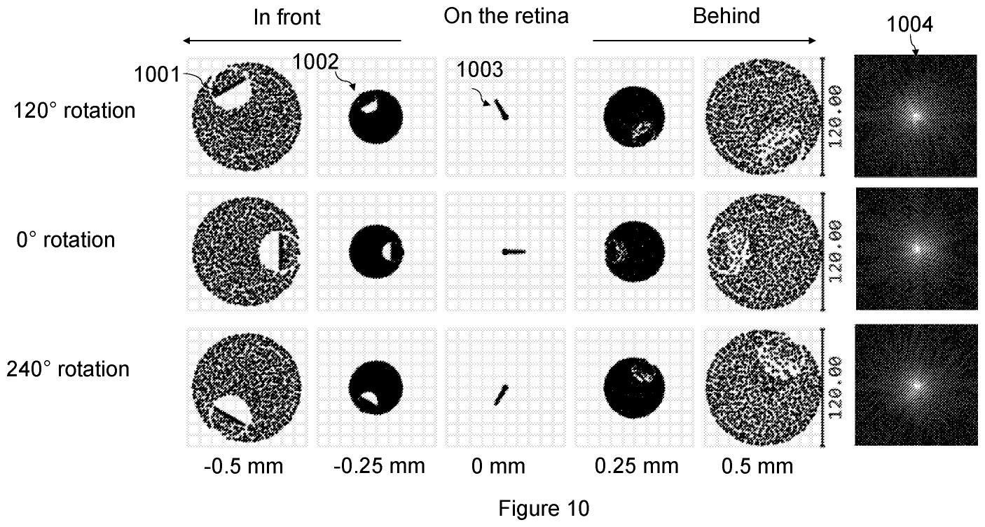

FIG. 10 illustrates the through-focus geometric spot analysis and the corresponding on-axis point spread functions (1004) when the −3 D myopic model eye of Table 2 is corrected with the contact lens described in FIGS. 9A and 9B in three configurations. In this example, the through-focus geometric spot analysis was performed at the following locations: −0.5 mm and −0.25 mm in front of the retina, on the retina and +0.25 mm and +0.5 mm behind the retina.

The on-eye rotation of the contact lens embodiment over time results in three configurations that provide a temporally and spatially varying signal on the retina. In this example, the three configurations represent the test case wherein the half-meridian with the power of −1.25 DS of the lens is located at 0°, 120° and 240° azimuthal positions over time with contact lens rotation. In this example, for each contact lens configuration, depicted as rows, the azimuthally and meridionally varying power distribution (i.e., Cosine-Variant I Region) configured within the second region of the optical zone results in a regional conoid or an interval of partial blur (1001, 1002, 1003) that is formed substantially in front of the retina within the through-focus image profile, in the parafoveal or paramacular region.

As can be seen in FIG. 10, the regional conoid or interval of partial blur about the retinal plane formed by the decentred second region within the optic zone of FIG. 9B can be observed by inspecting the through-focus spot diagram which has a diffuse spread of rays or light energy over about 120 μm central region of the retina. Within the through-focus spot diagram, there is a distinct region formed with minimal spread of rays or light energy, that contains the irregular blur pattern of the conoid or interval of partial blur (1001 and 1003). The orientation of the irregular blur pattern (1001 and 1003) and the corresponding point spread function (1004) change with the orientation of the contact lens on the eye, providing temporally and spatially varying directional cues for the eye. The region surrounding the graft of the decentred second region on the optical zone may be smoothed out to minimise any optical jumps in power and to minimise any visual performance degradation caused by significant changes in power caused due to abrupt changes in the surface curvatures at the junction of the said graft of the second region. In some examples, the blending of the decentred second region with the remainder of the optic zone may be achieved by allowing the lathe to spin at a desired or optimal speed while manufacturing the said lens. In some other exemplary embodiments, the blending of the decentred second region with the optic zone may not be the desired outcome.

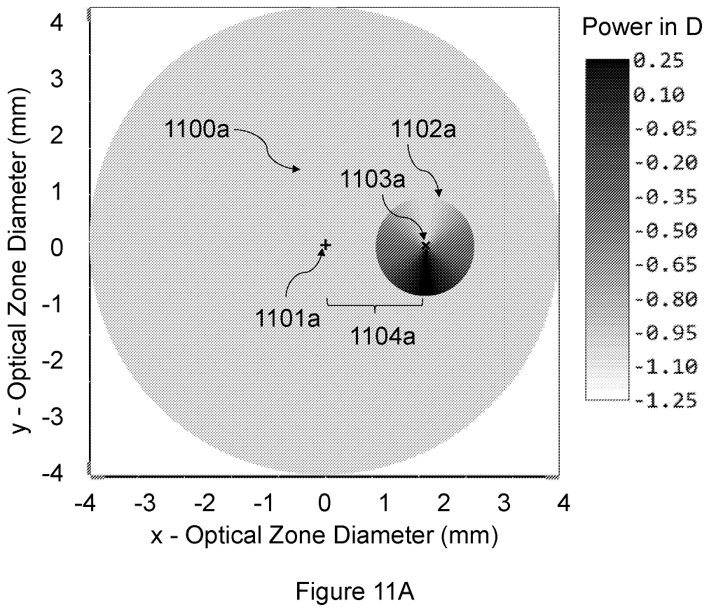

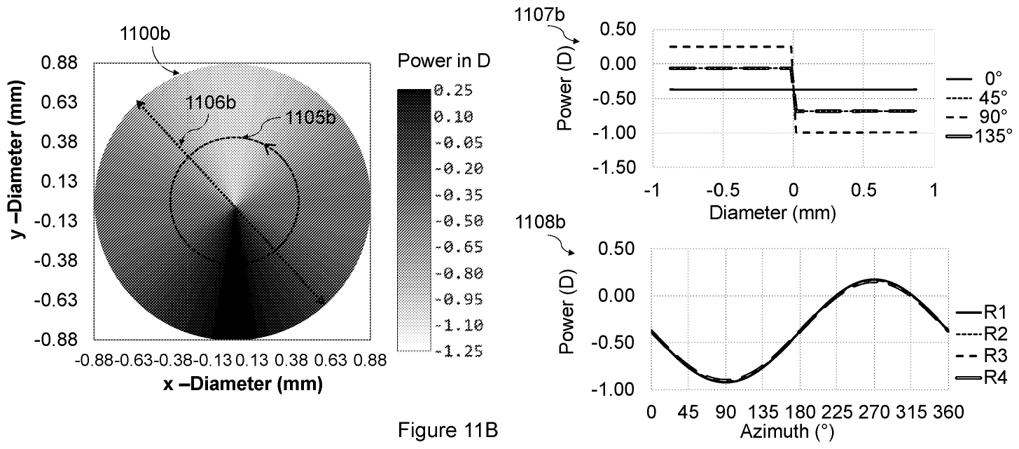

FIG. 11A illustrates the two-dimensional power map (in D) of a contact lens embodiment of this disclosure across an 8 mm optic zone diameter (1100a). The optic zone (1100a) of the contact lens is meant to be grafted onto a non-optical peripheral carrier zone with or without rotation assisting features. The contact lens has a sphere power of −1 DS in the optic zone (1100a) to correct the −1 DS myopic eye and an azimuthally and meridionally varying power distribution in the second region (1102a) within the optic zone (1100a). The second region (1102a) within the optical zone (1100a) has a diameter of 1.75 mm and its geometrical centre (1103a) is decentred by 1 mm from the optical centre (1101a) of the optic zone (1100a). The blending width is 0.05 mm.

FIG. 11B illustrates the power map distribution (1100b) of the second region (1102a) comprising an azimuthally and meridionally varying power distribution (Cosine-Variant I Region), and the power changes along one azimuth (1105b) and along one meridian (1106b) within the power map. FIG. 11B also shows the corresponding power profiles as a function of second region diameter for four representative sample meridians 0°, 45°, 90° and 135° (1107b), and its corresponding power profiles as a function of azimuth for four representative sample radial positions R1, R2, R3 and R4 (1108b) with radial distances of 0.15, 0.3, 0.45 and 0.6 mm, respectively. The second region (1102a) of the optic zone (1100a) of the contact lens is configured with a substantially radially invariant, meridionally and azimuthally variant, power distribution (power: −1 DS/+1.25 D, Cosine-Variant I Region). As can be seen in 1107b and 1108b, the power distribution in the area defined by the azimuthal angle of 0° to 180° varies between approximately −0.4 D, −0.7 D and −1 D for the 0°, 45°/135° and 90° meridians, respectively, and in the area defined by the azimuthal angle of 180° to 360° the power varies between approximately −0.4 D, 0 D and +0.2 D for the 0°, 45°/135° and 90° meridians, respectively, resulting in a delta power of approximately 1.2 D.

In some other embodiments, the azimuthally varying power distribution of the second region may be configured such that it resembles a saw-tooth or a triangular shaped profile. That is, the azimuthal power variation at any arbitrary radial distance from the geometric centre of the second region, would have a linear increase in power as function of the azimuthal angle until it reaches a peak or desired or threshold value and then reverses back to the start power linearly.

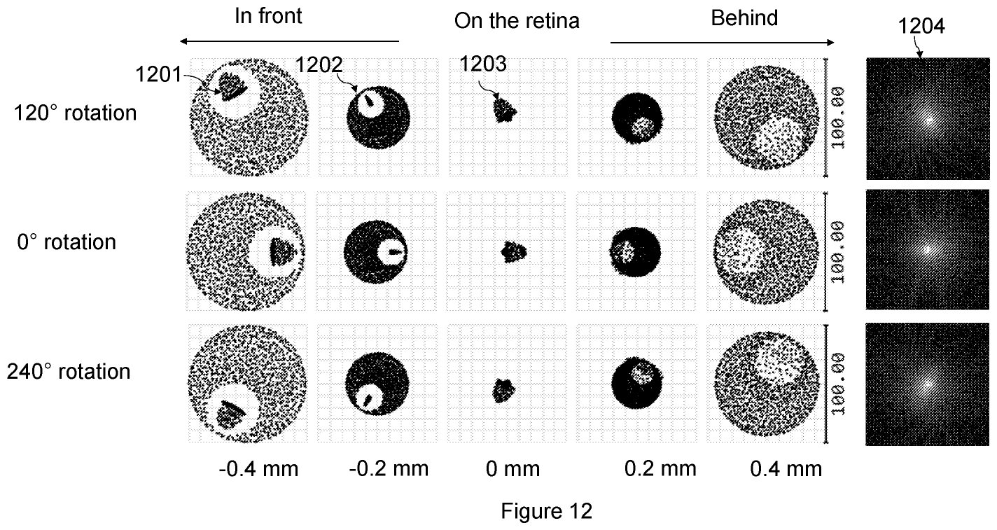

FIG. 12 illustrates the through-focus geometric spot analysis and the corresponding on-axis point spread functions (1204) when the −1 D myopic model eye is corrected with the contact lens described in FIGS. 11A and 11 in three configurations. In this example, the through-focus geometric spot analysis was performed at the following locations: −0.4 mm and −0.2 mm in front of the retina, on the retina and +0.2 mm and +0.4 mm behind the retina.

The on-eye rotation of the contact lens embodiment over time results in three configurations that provide a temporally and spatially varying signal on the retina. In this example, the three configurations represent the test case wherein the half-meridian with the power of −0.4 DS of the lens is located at 0°, 120° and 240° azimuthal positions over time with contact lens rotation. In this example, for each contact lens configuration, depicted as rows, the azimuthally and meridionally varying power distribution (i.e., Cosine-Variant I Region) configured within the second region of the optical zone results in a regional conoid or an interval of partial blur (1201, 1202, 1203) that is formed substantially in front of the retina within the through-focus image profile, in the parafoveal or paramacular region.

As can be seen in FIG. 12, the regional conoid or interval of partial blur about the retinal plane formed by the decentred second region within the optic zone of

FIG. 11B can be observed by inspecting the through-focus spot diagram which has a diffuse spread of rays or light energy over about 100 μm central region of the retina. Within the through-focus spot diagram, there is a distinct region formed with minimal spread of rays or light energy, that contains the irregular blur pattern of the conoid or interval of partial blur (1201 and 1203). The orientation of the irregular blur pattern (1201 and 1203) and the corresponding point spread function (1204) change with the orientation of the contact lens on the eye, providing temporally and spatially varying directional cues for the eye.

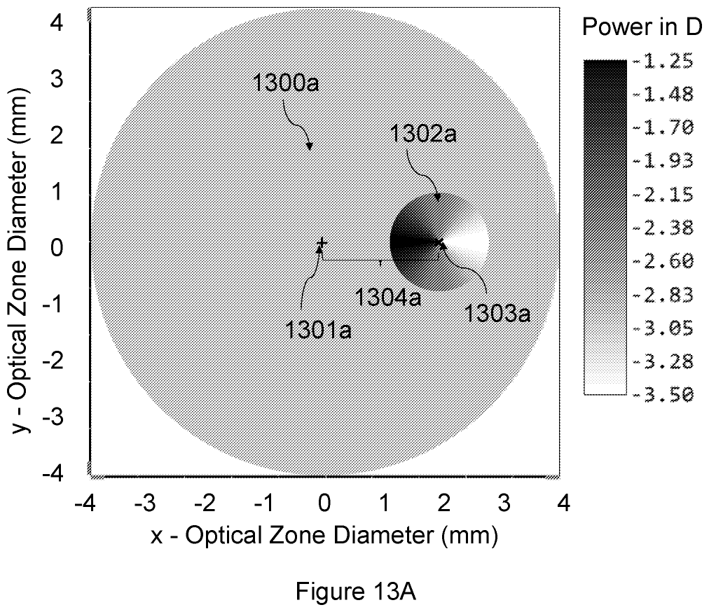

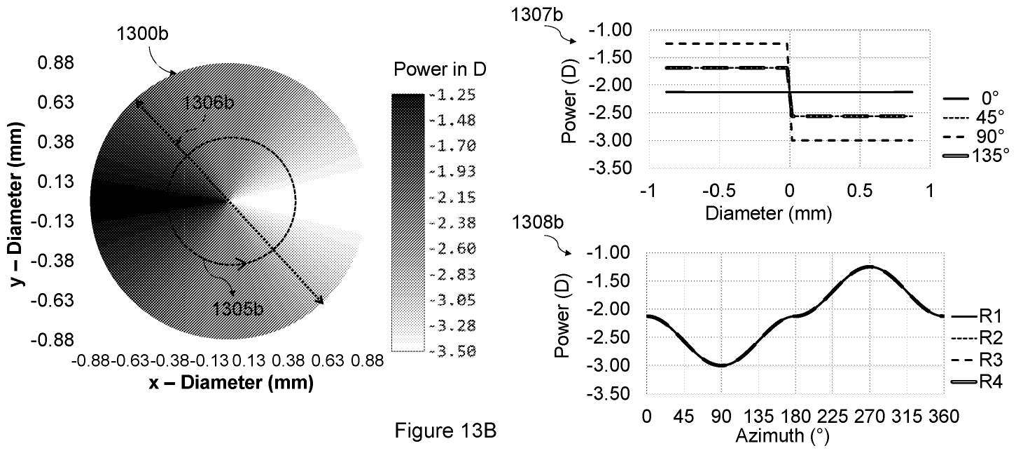

FIG. 13A illustrates the two-dimensional power map (in D) of a contact lens embodiment of this disclosure across an 8 mm optic zone diameter (1300a). The optic zone (1300a) of the contact lens is meant to be grafted onto a non-optical peripheral carrier zone with rotation assisting features. The contact lens has a sphere power of −3 DS in the optic zone (1300a) to correct the −3 DS myopic eye (Table 2) and an azimuthally and meridionally varying power distribution in the second region (1302a) within the optic zone (1300a). The second region (1302a) within the optical zone (1300a) has a diameter of 1.75 mm and its geometrical centre (1303a) is decentred by 1.25 mm from the optical centre (1301a) of the optic zone (1300a). The blending width is 0.075 mm.

FIG. 13B illustrates the power map distribution (1300b) of the second region (1302a) comprising an azimuthally and meridionally varying power distribution (Cosine-Variant II Region), and the power changes along one azimuth (1305b) and along one meridian (1306b) within the power map. FIG. 13B also shows the corresponding power profiles as a function of second region diameter for four representative sample meridians 0°, 45°, 90° and 135° (1307b), and its corresponding power profiles as a function of azimuth for four representative sample radial positions R1, R2, R3 and R4 (1308b) with radial distances of 0.15, 0.3, 0.45 and 0.6 mm, respectively.

The second region (1302a) of the optic zone (1300a) of the contact lens is configured with a substantially radially invariant, meridionally and azimuthally variant, power distribution (power: −3 DS/+1.75 D, Cosine-Variant II Region). As can be seen in 1307b and 1308b, the power distribution in the area defined by the azimuthal angle of 0° to 180° varies between approximately −2.12 D, −2.6 D and −3 D for the 0°, 45°/135° and 90° meridians, respectively, and in the area defined by the azimuthal angle of 180° to 360° the power varies between approximately −2.12 D, −1.7 D and −1.25 D for the 0°, 45°/135° and 90° meridians, respectively, resulting in a delta power of approximately 1.75 D.

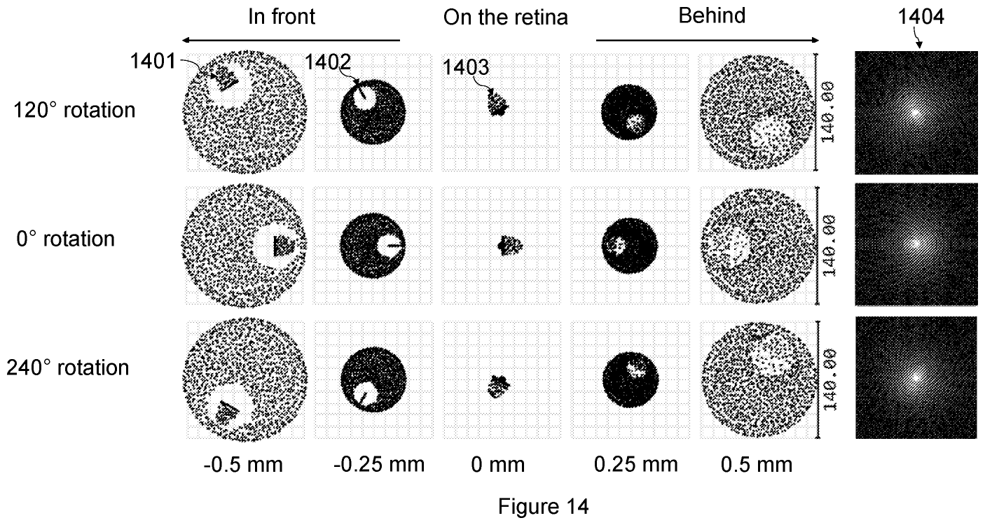

FIG. 14 illustrates the through-focus geometric spot analysis and the corresponding on-axis point spread functions (1404) when the −3 D myopic model eye is corrected with the contact lens described in FIGS. 13A and 13B in three configurations. In this example, the through-focus geometric spot analysis was performed at the following locations: −0.5 mm and −0.25 mm in front of the retina, on the retina and +0.25 mm and +0.5 mm behind the retina.

The on-eye rotation of the contact lens embodiment over time results in three configurations that provide a temporally and spatially varying signal on the retina. In this example, the three configurations represent the test case wherein the half-meridian with the power of −3 DS of the lens is located at 0°, 120° and 240° azimuthal positions over time with contact lens rotation. In this example, for each contact lens configuration, depicted as rows, the azimuthally and meridionally varying power distribution (i.e., Cosine-Variant II Region) configured within the second region of the optical zone results in a regional conoid or an interval of partial blur (1401, 1402, 1403) that is formed substantially in front of the retina within the through-focus image profile, in the parafoveal or paramacular region.

As can be seen in FIG. 14, the regional conoid or interval of partial blur about the retinal plane formed by the decentred second region within the optic zone of FIG. 13B can be observed by inspecting the through-focus spot diagram which has a diffuse spread of rays or light energy over about 140 μm central region of the retina. Within the through-focus spot diagram, there is a distinct region formed with minimal spread of rays or light energy, that contains the irregular blur pattern of the conoid or interval of partial blur (1401 and 1403). The orientation of the irregular blur pattern (1401 and 1403) and the corresponding point spread function (1404) change with the orientation of the contact lens on the eye, providing temporally and spatially varying directional cues for the eye.

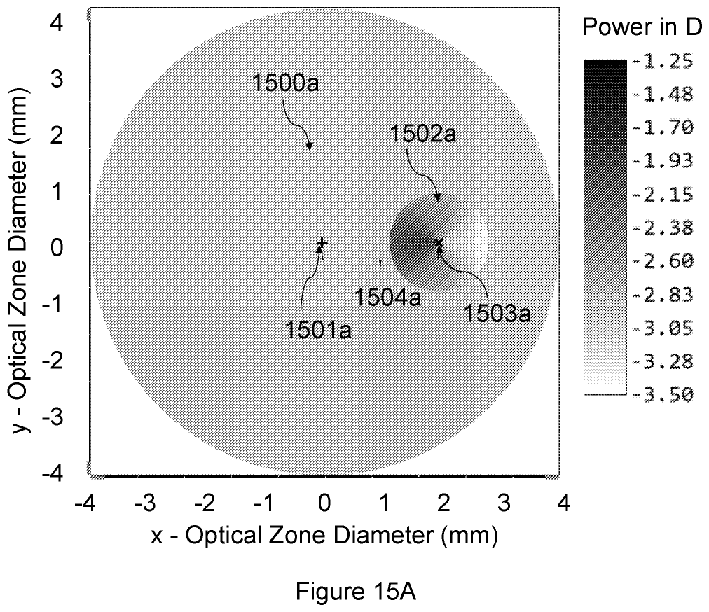

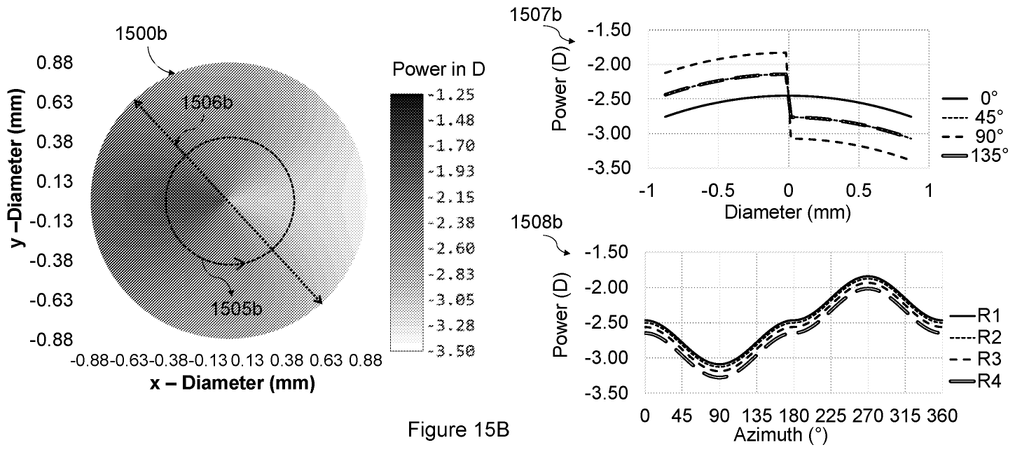

FIG. 15A illustrates the two-dimensional power map (in D) of a contact lens embodiment of this disclosure across an 8 mm optic zone diameter (1500a). The optic zone (1500a) of the contact lens is meant to be grafted onto a non-optical peripheral carrier zone with rotation assisting features. The contact lens has a sphere power of −3 DS in the optic zone (1500a) to correct the −3 DS myopic eye (Table 2) and an azimuthally, meridionally and radially varying power distribution in the second region (1502a) within the optic zone (1500a). The second region (1502a) within the optical zone (1500a) has a diameter of 1.75 mm and its geometrical centre (1503a) is decentred by 1.25 mm from the optical centre (1501a) of the optic zone (1500a). The blending width is 0.075 mm.

FIG. 15B illustrates the power map distribution (1500b) of the second region (1502a) comprising an azimuthally, meridionally and radially varying power distribution (Cosine-Variant III Region), and the power changes along one azimuth (1505b) and along one meridian (1506b) within the power map. FIG. 15B also shows the corresponding power profiles as a function of second region diameter for four representative sample meridians 0°, 45°, 90° and 135° (1507b), and its corresponding power profiles as a function of azimuth for four representative sample radial positions R1, R2, R3 and R4 (1508b) with radial distances of 0.15, 0.3, 0.45 and 0.6 mm, respectively. The second region (1502a) of the optic zone (1500a) of the contact lens is configured with a substantially radially variant, meridionally and azimuthally variant, power distribution (power: −3 DS/+1.25 D, Cosine-Variant III Region). As can be seen in 1507b and 1508b, the power distribution in the area defined by the azimuthal angle of 0° to 180° varies between approximately −2.4 to −2.6 D, −2.7 to −3.2 D and −2.8 to −3.25 D for the 0°, 45°/135° and 90° meridians, respectively, and in the area defined by the azimuthal angle of 180° to 360° the power varies between approximately −2.7 to −2.4 D, −2.2 to −2.1 D and −2 to −1.9 D for the 0°, 45°/135° and 90° meridians, respectively, resulting in a delta power of approximately 1.25 D.

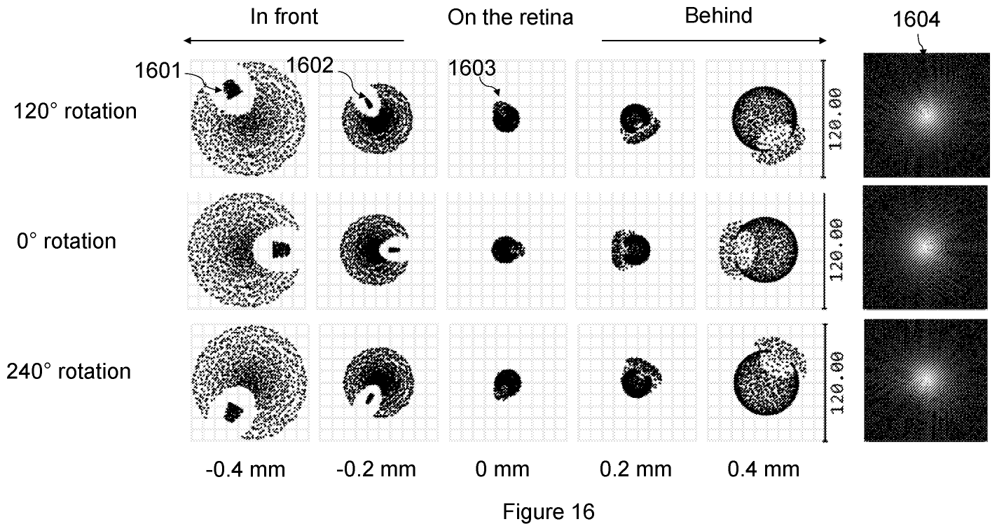

FIG. 16 illustrates the through-focus geometric spot analysis and the corresponding on-axis point spread functions (1604) when the −3 D myopic model eye is corrected with the contact lens described in FIGS. 15A and 15B in three configurations. In this example, the through-focus geometric spot analysis was performed at the following locations: −0.4 mm and −0.2 mm in front of the retina, on the retina and +0.2 mm and +0.4 mm behind the retina.

The on-eye rotation of the contact lens embodiment over time results in three configurations that provide a temporally and spatially varying signal on the retina. In this example, the three configurations represent the test case wherein the half-meridian with the power of −3 DS of the lens is located at 0°, 120° and 240° azimuthal positions over time with contact lens rotation. In this example, for each contact lens configuration, depicted as rows, the azimuthally, meridionally and azimuthally varying power distribution (i.e., Cosine-Variant III Region) configured within the second region of the optical zone results in a regional conoid or an interval of partial blur (1601, 1602, 1603) that is formed substantially in front of the retina within the through-focus image profile, in the parafoveal or paramacular region.

As can be seen in FIG. 16, the regional conoid or interval of partial blur about the retinal plane formed by the decentred second region within the optic zone of FIG. 15B can be observed by inspecting the through-focus spot diagram which has a diffuse spread of rays or light energy over about 120 μm central region of the retina. Within the through-focus spot diagram, there is a distinct region formed with minimal spread of rays or light energy, that contains the irregular blur pattern of the conoid or interval of partial blur (1501 and 1503). The orientation of the irregular blur pattern (1501 and 1503) and the corresponding point spread function (1504) change with the orientation of the contact lens on the eye, providing temporally and spatially varying directional cues for the eye.

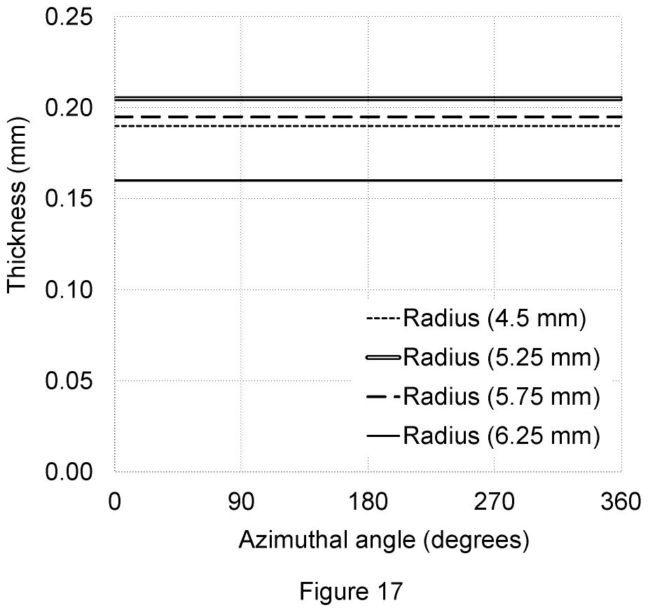

FIG. 17 illustrates the thickness distribution as a function of azimuthal angle of the contact lens described in FIGS. 2A and 3A along four sample radial distances 4.5 mm, 5.25 mm, 5.75 mm, and 6.25 mm within the non-optical peripheral zone. As can be seen from FIG. 17, independent of radial distance the thickness of the contact lens is substantially invariant as a function of azimuthal angle with a peak-to-valley of <5 μm. Furthermore, the maximum difference in thickness between the different radii is about 0.04 mm.

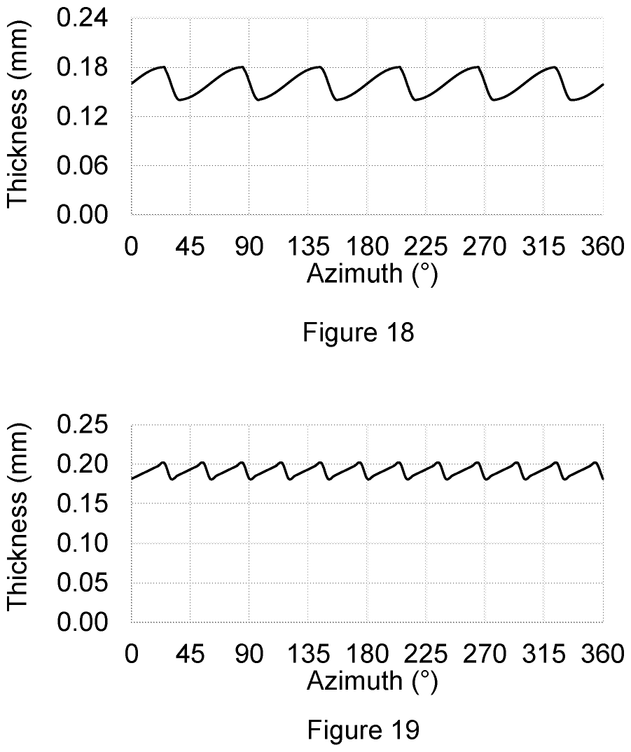

FIG. 18 shows the thickness as a function of azimuthal angle along the peripheral carrier zone of a left contact lens at an average radial distance of about 5 mm for an exemplary contact lens described in FIGS. 2B and 3B, which will result in an assisted anti-clockwise (i.e., nasally downwards) rotation of the contact lens on eye. The peripheral lens thickness changes in the form of a sawtooth profile, which has a total of about 6 teeth and wherein the amplitude of each sawtooth is about 0.04 mm, i.e., the thickness varies between approximately 0.14 and 0.18 mm. The number of teeth can be increased by up to 20 to minimise potential discomfort. In some embodiments, sharp junctions within the sawtooth profile and between the sawtooth and the optic zone on the inside and the edge on the outside may also be blended.

In some other examples of the present disclosure, a preferred embodiment of the saw tooth profile may be configured such that the angle of the saw teeth may be optimised and configured differently between right and left eyes, taking into consideration that the eye-lid interaction while wearing contact lenses may produce forces on the lenses that may be in different directions for the right and left eyes. In some examples, a preferred embodiment includes the rotational assisting features that are complementary to the natural direction of rotation and not work against the natural direction of rotation.

FIG. 19 shows the thickness as a function of azimuthal angle along the peripheral carrier zone of another left contact lens at an average radial distance of about 5.5 mm for an exemplary contact lens described in FIGS. 2B and 3B, which will result in an assisted anti-clockwise (i.e., nasally downwards) rotation of the contact lens on eye. The peripheral lens thickness changes in the form of a sawtooth profile, which has a total of about 12 teeth and wherein the amplitude of each sawtooth is about 0.02 mm, i.e., the thickness varies between approximately 0.2 and 0.18 mm.

Peripheral thickness profiles as shown in FIGS. 18 and 19 can assist with the rotation on or around about the optical centre of the contact lens, due to the natural blink facilitated by the combined action of the upper and lower eyelids.

In certain embodiments, the decentred second region within the optical zone of the contact lens, may be at least 0.5 mm, 0.75 mm, 1 mm, 1.5 mm, or 2.5 mm in diameter for a circular shape or wide along the minor axis of another regular or an irregular shaped second region.

In certain embodiments, the decentred second region within the optical zone of the contact lens, may be between 0.5 mm to 1.25 mm, 0.5 mm to 1.75 mm, 0.75 to 2.5 mm or 0.5 mm to 3.5 mm in diameter along the minor or major axes of the circular or irregular shaped second region.

In certain embodiments, the surface area of the decentred second region within the optical zone of the contact lens, may be between 0.5 mm² to 5 mm², 2.5 mm² to 7.5 mm², 5 mm² to 10 mm², or 1 mm² to 25 mm².

In certain embodiments, the surface area of the decentred second region is at least 10% and no greater than 35% of the surface area of the optical zone. In certain embodiments, the surface area of the decentred second region is at least 5% and no greater than 30% of the surface area of the optical zone. In certain embodiments, the surface area of the decentred second region is at least 3% and no greater than 20% of the surface area of the optical zone. In certain embodiments, the surface area of the decentred second region is at least 5% and no greater than 40% of the surface area of the optical zone.

In certain embodiments, the distance between the geometric centre of the second region within the optical zone configured rotationally asymmetric about its geometric centre and the optical centre may be at least 0.75 mm, 1 mm, 1.5 mm, 2 mm, or 2.5 mm.

In certain embodiments, the distance between the geometric centre of the second region within the optical zone configured rotationally asymmetric about its geometric centre and the optical centre, may be between 0.75 mm to 1.25 mm, 0.75 mm to 1.75 mm, 1 mm to 2 mm or 0.75 mm to 2.5 mm.

In certain embodiments, the optical zone of the contact lens may be at least 6 mm, 6.5 mm, 7 mm, 7.5 mm, 8 mm, 8.5 mm, or 9 mm in diameter. In certain embodiments, the optical zone of the contact lens may be between 6 mm to 7 mm, 7 mm to 8 mm, 7.5 mm to 8.5 mm, or 7 to 9 mm in diameter.

In certain embodiments, the blend zone or blending zone of the contact lens may be at least 0.05 mm, 0.1 mm, 0.15 mm, 0.25 mm, 0.35 or 0.5 mm in width.

In certain embodiments, the blend zone or blending zone of the contact lens may be between 0.05 mm and 0.15 mm, 0.1 mm and 0.3 mm, or 0.25 mm and 0.5 mm in width.

In some embodiments, the blending zone may be symmetrical, for example circular, and yet in some other embodiments, the blending zone may be asymmetrical, for example, elliptical or irregular. In other embodiments, the width of the blending zone may be reduced to zero and thus non-existent.

In exemplary embodiments, the shape of the second region within the optical zone may be circular, semi-circular, non-circular, oval, rectangular, hexagonal, square, irregular or combinations thereof to introduce the desired stop signal for the progressing myopic eye. In certain embodiments, the area of the second region within the optical zone configured rotationally asymmetric about the optical axis may be at least 5%, 10%, 15%, 20%, 25%, 30% or −35% of the optical zone.

In certain embodiments, the area of the second region within the optical zone configured rotationally asymmetric about the optical axis may be between 5% and 10%, 10% and 20%, 10% and 25%, between 5% and 20%, between 5% to 25%, between 10% and 30% or between 5% and 35% of the optical zone.

In certain embodiments, the peripheral non-optical zone or carrier zone of the contact lens may be at least 2.25 mm, 2.5 mm, 2.75 mm, or 3 mm in width. In certain embodiments, the peripheral zone or carrier zone of the contact lens may be between 2.25 mm and 2.75 mm, 2.5 mm and 3 mm, or 2 mm and 3.5 mm in width.

In certain embodiments, the peripheral zone or the carrier zone of the contact lens is substantially symmetric with substantially similar radial thickness profiles across horizontal, vertical, and other oblique meridians.

In certain embodiments, the peripheral zone or the carrier zone of the contact lens is substantially symmetric with substantially similar radial thickness profiles across horizontal, vertical and other oblique meridians which may mean that the maximum thickness of the peripheral carrier zone across any of the meridians is within 5%, 6%, 7%, 8%, 9%, or 10% variation of the maximum thickness of any other meridian. For the avoidance of doubt, the thickness profiles are measured in the radial direction.

In certain embodiments, the peripheral zone or the carrier zone of the contact lens is substantially symmetric with substantially similar radial thickness profiles across horizontal, vertical and other oblique meridians which may mean that the maximum thickness of the peripheral carrier zone across any of the half meridians is within 5%, 6%, 7%, 8%, 9%, or 10% variation of the maximum thickness of any other half meridian.

In certain embodiments, the peripheral zone or the carrier zone of the contact lens is substantially rotationally symmetric with substantially similar radial thickness profiles across horizontal, vertical and other oblique meridians, which may mean that the thickest point within the peripheral carrier zone across any of the meridians is within a maximum variation of 5, 10, 15, 20, 25, 30, 35, or 40 μm of the thickest peripheral point of any other meridian. the avoidance of doubt, the thickness profiles are measured in the radial direction.

In certain embodiments, the peripheral zone or the carrier zone of the contact lens is substantially rotationally symmetric with substantially similar radial thickness profiles across horizontal, vertical and other oblique meridians, which may mean that the thickest point within the peripheral carrier zone across any of the half meridians is within a maximum variation of 5, 10, 15, 20, 25, 30, 35, or 40 μm of the thickest peripheral point of any other half meridian. For the avoidance of doubt, the thickness profile is measured in the radial direction.

In certain embodiments, the peripheral zone or the non-optical carrier zone of the contact lens is configured to be substantially free of a ballast, a prism ballast, a peri-ballast, a slab-off, a truncation or combinations thereof, which are commonly used in conventional toric contact lenses aimed at stabilising the orientation of the contact lens on the eye.

In certain embodiments, substantially free rotation of the contact lens over time may be a rotation by 360 degrees at least once, twice, thrice, four, five or ten times per day and at least 10, 15, 20, or 25 degrees within 1 hour of lens wear.

In other embodiments, substantially free rotation of the contact lens over time may be a rotation by 90 degrees, at least once, twice, thrice, four, five or ten times per day and at least 10, 15, 20, or 25 degrees within 2 hours of lens wear. In some embodiments, the rotationally asymmetric decentred second region of the contact lens can be located, formed, or placed on the anterior surface, posterior surface, or combinations thereof.

In some embodiments, the rotationally asymmetric decentred second region of the contact lens can be located, formed, or placed at least in part on the anterior surface, at least part on the posterior surface, or at least in part on the anterior surface and at least in part on the posterior surface.

In some embodiments, the meridionally and azimuthally variant power distribution within the second region of the contact lens is devoted to producing specific features of the stop signal, for example positioning the regional conoid or interval of partial blur induced at a desired location of the peripheral retina.

In some examples, the optics of the decentred second region of the contact lens may be configured to provide a regional conoid or interval of partial blur substantially in front of the retinal plane, approximately on the retinal plane or substantially behind the retinal plane.

In certain other embodiments, the base prescription of the contact lens located, formed, or placed on one of the two surfaces of the contact lens and the other surface may have other features for further reducing eye growth.

In certain embodiments, the shape of the decentred second region within the optical zone, the blending zones between the decentred second region and the remainder of the optic zone, the blending zones of the optical zone and the peripheral carrier zone may be described by one or more of the following: a sphere, an asphere, an extended odd polynomial, an extended even polynomial, a conic section, a piecewise polynomial, or a biconic section.

In certain embodiments, there may be distinct advantages in combining the contact lens embodiments in the disclosure with prescription spectacle lenses; wherein only one single stock-keeping unit with a second region that has a preferred meridionally and azimuthally variant power distribution of desirable or preferred size and shape, or other device feature may be required to achieve the desired optical effect on the retina. To enhance wearability and varying treatment signals, only one contact lens could be worn alternating daily between left and right eyes.

Another distinct advantage of combining the current contact lens embodiments of the present disclosure with prescription spectacle lenses is to deal with inherently astigmatic eyes; wherein the astigmatic or cylindrical correction can be incorporated into the pair of spectacle lenses.

Again, in such a case, a single stock-keeping unit can then be worn as a contact lens without no concern relating to the overlapping powers of a cylinder and/or induced meridionally and azimuthally variant power distribution of the decentred second region or any other contemplated device feature.

As a person skilled in the art may appreciate that the present invention may be used in combination with any of the devices/methods that have the potential to influence the progression of myopia.

These may include but are not limited to, spectacle lenses of various designs, colour filters, pharmaceutical agents, behavioural changes, and environmental conditions.

Few other exemplary embodiments are described in the following examples sets.

### Example Set “A”—Meridionally and Azimuthally Variant Power Distribution Within the Second Region

A contact lens for an eye, the contact lens including an optical zone around an optical centre and a non-optical peripheral carrier zone about the optical zone; wherein the optical zone is configured with a substantially single vision power distribution providing substantial correction for the eye, and a decentred second region comprising at least a power map, the power map characterised by a plurality of meridional power distributions across the optic zone and a plurality of azimuthal power distributions about the optical axis, resulting in a delta power; wherein at least one of the azimuthal power distributions is partially variant and is devoid of mirror symmetry;

and wherein at least one of the meridional power distributions is partially variant and is devoid of mirror symmetry; and wherein the decentred region with a geometric centre is located substantially away from the optical centre providing at least in part a regional conoid of partial blur on the retina of the eye; and wherein the non-optical peripheral carrier zone comprises a plurality of azimuthal thickness distributions about the optical axis, wherein the azimuthal thickness distribution is configured to facilitate a specific fit on the eye.

The contact lens of one or more of the claims of the example set A, wherein the at least one of the azimuthal power distributions is defined using a cosine distribution with reduced frequency, that is, one-fourth (¼), or half (½) of a normal frequency; wherein the normal frequency is defined with two cosine cycles over 360° or 2π radians.

The contact lens of one or more of the claims of the example set A, wherein only one of the pluralities of the meridional power distributions has mirror symmetry along the optic zone and none of the pluralities of the azimuthal power distributions has mirror symmetry about the optical axis.

The contact lens of one or more of the claims of the example set A, wherein the at least one of the partially variant meridional power distributions is radially variant.

The contact lens of one or more of the claims of the example set A, wherein the at least one of the partially variant meridional power distributions is radially invariant.

The contact lens of one or more of the claims of the example set A, wherein the surface area of the second region within the optical zone comprises at least 10% and no greater than 35% of the optical zone.

The contact lens of one or more of the claims of the example set A, wherein the shape of the second region within the optical zone is substantially circular or elliptical.

The contact lens of one or more of the claims of the example set A, wherein the location of the geometric centre of the second region is at least 1.5 mm, 1.75 mm, 2 mm, 2.25 mm, 2.5 mm, or 3 mm, away from the optic centre of the contact lens.

The contact lens of one or more of the claims of the example set A, wherein the delta power is at least +1.25 D, at least +1.5 D, at least +1.75 D, at least +2 D, at least +2.25 D, or at least +2.5 D.

The contact lens of one or more of the claims of the example set A, wherein the delta power is between +0.5D and +2.75 D, +0.75D and +2.5 D, +1D and +2.25 D, +1.25D and +2D, or +1.25D and +2.75 D.

The contact lens of one or more of the claims of the example set A, wherein the second region is further combined with the primary spherical aberration of at least +0.25 D defined over the minimum diameter of the second region.

The contact lens of one or more of the claims of the example set A, wherein the second region is further combined with the primary spherical aberration of at least −0.25 D defined over the minimum diameter of the second region.

The contact lens of one or more of the claims of the example set A, wherein the second region within the optical zone is configured on an anterior surface or posterior surface of the contact lens.

The contact lens of one or more of the claims of the example set A, wherein the second region of the optical zone is configured in part by an anterior surface and in part by a posterior surface of the contact lens.

The contact lens of one or more of the claims of the example set A, wherein a blending zone is configured between the optic zone and the second region;

and wherein the blending zone spans at least 0.025 mm, 0.05 mm, 0.075 mm, or 0.1 mm measured on a half diameter across the optical zone of the contact lens.

The contact lens of one or more of the claims of the example set A, wherein a blending zone is configured between the optic zone and the non-optical peripheral zone; and wherein the blending zone spans at least 0.125 mm, 0.25 mm, 0.5 mm, 0.75 mm, or 1 mm measured on a half diameter across the optical zone of the contact lens.

The contact lens of one or more of the claims of the example set A, wherein the plurality of azimuthal thickness distributions of the non-optical peripheral carrier zone is configured substantial invariant about the optical axis.

The contact lens of one or more of the claims of the example set A, wherein a difference between a thickest point and a thinnest point within the plurality of azimuthal distributions of the non-optical peripheral carrier zone about the optical axis provides a peak-to-valley thickness.

The contact lens of one or more of the claims of the example set A, wherein the substantial invariance means a variation such that a peak-to-valley thickness is between 5 μm and 45 μm, or between 10 μm and 45 μm or between 1 μm and 45 μm.

The contact lens of one or more of the claims of the example set A, wherein the substantial invariance means a variation such that a peak-to-valley thickness is no more than 5 μm, 10 μm, 15 μm, 20 μm, 25 μm, 30 μm, 35 μm, 40 μm, or 45 μm.

The contact lens of one or more of the claims of the example set A, wherein the plurality of azimuthal thickness distributions are defined with a desired width spanning a range of arbitrary radial distances in the non-optical peripheral carrier zone, wherein the desired width is between 3.5 mm and 7.2 mm, 4 mm and 7.5 mm, 4.5 mm and 6.5 mm, 4.25 mm and 7 mm, or 4.5 mm and 7.1 mm, of the non-optical peripheral carrier zone.

The contact lens of one or more of the claims of the example set A, wherein the non-optical peripheral carrier zone comprises thickness distributions defined within a selected region along one or more half-meridians configured substantially invariant; wherein the substantial invariance means a variation in thickness distribution along any half-meridian is less than 3%, 5% or 8% of any other half-meridians.

The contact lens of one or more of the claims of the example set A, wherein the non-optical peripheral carrier zone comprises thickness distributions defined within a selected region along one or more half-meridians are configured substantially invariant; wherein the substantial invariance in the thickness distribution is such that a thickest point across any one of the half-meridians is within a maximum variation of 5 μm, 10 μm, 15 μm, 20 μm, 25 μm, 30 μm, 35 μm, 40 μm, or 45 μm of the thickest point of any other half-meridian within the non-optical peripheral carrier zone.

The contact lens of one or more of the claims of the example set A, wherein the selected region along one or more arbitrary half-meridians is between 3.5 mm and 7.2 mm, 4 mm and 7.1 mm, 3.75 mm and 7 mm, or 4 mm and 7.2 mm, of the non-optical peripheral carrier zone.

The contact lens of one or more of the claims of the example set A, wherein the specific fit allows a substantially free rotation on the myopic eye; wherein the substantially free rotation is gauged as a rotation of the contact lens by 180 degrees at least thrice per 8 hours of lens wear, and at least 15 degrees within 1 hour of lens wear.

The contact lens of one or more of the claims of the example set A, wherein the specific fit is configured with at least one rotation assisting feature; wherein the at least one rotation assisting feature is represented using a periodic function with a periodicity; wherein the periodic function is a saw-tooth profile, a sinusoidal profile, a sum of sinusoidal profiles, or a quasi-sinusoidal profile; wherein the periodicity of the periodic function is no less than 6 defined over 0 to 2π radians, and the rate of thickness change is different for the increase than for the decrease.

The contact lens of one or more of the claims of the example set A, wherein the maximum thickness variation within the at least one rotation assisting feature is between 10 μm to 45 μm.

The contact lens of one or more of the claims of the example set A, wherein the regional conoid of partial blur has a depth of at least 0.2 mm, 0.5 mm, 0.75 mm, or 1 mm, at the retina of the eye.

The contact lens of one or more of the claims of the example set A, wherein the regional conoid of partial blur spans at least sub-foveal, foveal, sub-macular, macular, or para macular regions of the retina of the eye.

The contact lens of one or more of the claims of the example set A, wherein the regional conoid of partial blur is at least within 2.5 degrees, 5 degrees, 7.5 degrees, 10 degrees, 15 degrees, 20 degrees, 25 degrees, 30 degrees, 35 degrees or 40 degrees field of the retina of the eye.

The contact lens of one or more of the claims of the example set A, wherein the regional conoid of partial blur is positioned on the retina such that it serves as a directional cue, or an optical stop signal, for the myopic eye.

The contact lens of one or more of the claims of the example set A, wherein the regional conoid of partial blur is not a regular conoid of Sturm and is irregular.

The contact lens of one or more of the claims of the example set A, wherein the regional conoid of partial blur includes a sagittal plane and a tangential plane; wherein tangential plane is located in front of the retina for at least one location within 40 degrees field of the retina of the eye.

The contact lens of one or more of the claims of the example set A, wherein sagittal plane is located in front of the retina for at least one location within 40 degrees field of the retina of the eye.

The contact lens of one or more of the claims of the example set A, wherein sagittal plane is located substantially close to the retina of the eye, for at least one location within 40 degrees field of the retina of the eye.

The contact lens of one or more of the claims of the example set A, wherein the at least one rotation assisting feature of the contact lens allows for increased rotation of the contact lens on the myopic eye, gauged as a rotation of the contact lens by 180 degrees at least thrice per 4 hours of lens wear, and at least 15 degrees within 30 minutes of lens wear.

The contact lens of one or more of the claims of the example set A, wherein the at least one rotation assisting feature is configured to increase rotation on the eye and in combination with the at least partially variant meridional and azimuthal power distribution within the second region, offers a temporally and spatially varying stop signal for the myopic eye such that the efficacy of the directional signal remains substantially consistent over time.

The contact lens of one or more of the claims of the example set A, wherein the power map in conjunction with the specific fit provides the eye with the regional conoid of partial blur that is temporally and spatially variant; wherein the spatial variance includes at least sub-foveal, foveal, sub-macular, macular, or para macular regions of the retina of the eye; and wherein the temporal variance provides a therapeutic benefit for the eye that remains substantially consistent over time.

The contact lens of one or more of the claims of the example set A, wherein the power map in conjunction with the specific fit provides the eye with the regional conoid of partial blur that is temporally and spatially variant; wherein the spatial variance includes 2.5 degrees, 5 degrees, 7.5 degrees, 10 degrees, 15 degrees, 20 degrees, 25 degrees, 30 degrees, 35 degrees or 40 degrees field of the retina of the eye; and wherein the temporal variance is provided by a rotation of the contact lens by 180 degrees at least thrice per 8 hours of lens wear, and at least 15 degrees within 1 hour of lens wear facilitating a therapeutic benefit for the eye that remains substantially consistent over time.

The contact lens of one or more of the claims of the example set A, wherein the specific fit offers a temporally and spatially varying directional cue, or optical stop signal, for the myopic eye to substantially control eye growth of the myopic eye.

The contact lens of one or more of the claims of the example set A, wherein the therapeutic benefit for the eye means myopia control, myopia management, slowing the rate of myopia progression, of the eye.

The contact lens of one or more of the claims of the example set A, wherein the visual performance with the contact lens is substantially similar to that of a single vision contact lens for the eye.

The contact lens of one or more of the claims of the example set A, wherein the at least one rotation assisting feature is selected to allow for a desired lens rotation providing a desired visual performance while maintaining the desired the spatially and temporally varying optical stop signal for the myopic eye such that the efficacy of the directional signal remains substantially consistent over time.

### Example Set “B”—Different Contact Lenses for Right and Left Eyes.

A contact lens pair, one contact lens for a right, one contact lens for a left, myopic eye, each contact lens comprising, a front surface, a back surface, an optical centre, an optical axis, an optical zone around the optical centre, a decentred second region within the optic zone; wherein the geometric centre of the decentred second region is located substantially away from the optical centre; and a non-optical peripheral carrier zone about the optical zone; the optical zone substantially comprising single vision power to correct the myopic eye; wherein the decentred second region comprises of a power map characterised by a plurality of meridional and azimuthal power distributions about across its geometric centre; wherein the at least one of the meridional and azimuthal power distributions is at least partially variant and is devoid of mirror symmetry; wherein the power map, at least in part, provides adequate correction for the myopic eye, and at least in part, provides a regional conoid of partial blur serving as a directional cue, or an optical stop signal, at the retina of the myopic eye; and the non-optical peripheral carrier zone comprising a plurality of azimuthal thickness distributions about the optical axis, wherein at least one of the azimuthal thickness distributions is configured to be substantially invariant to facilitate a specific fit on the myopic eye.

The contact lens pair of one or more of the claims of the example set B, wherein the plurality of meridional and azimuthal power distributions across the geometric centre of the decentred second region, for the right and left myopic eyes are substantially different.

The contact lens pair of one or more of the claims of the example set B, wherein the at least one rotation assisting feature of each of the contact lenses is configured differently between the right myopic eye and the left myopic eye.

The contact lens pair of one or more of the claims of the example set B, wherein the at least one rotation assisting feature of each of the contact lenses is configured mirror symmetrically, about the nose, between the right myopic eye and the left myopic eye.

The contact lens pair of one or more of the claims of the example set B, wherein the at least one rotation assisting feature of each of the contact lenses is configured mirror asymmetrically, about the nose, between the right myopic eye and the left myopic eye.

The contact lens pair of one or more of the claims of the example set B, wherein the at least one rotation assisting feature of each of the contact lenses is configured mirror asymmetrically, about the nose, between the right myopic eye and the left myopic eye such that each rotation assisting feature is selected to allow for different magnitudes of lens rotation between the right and left myopic eyes providing further increase in the spatially and temporally varying optical stop signal for the myopic eye such that the efficacy of the directional signal remains substantially consistent over time.

The contact lens pair of one or more of the claims of the example set B, wherein the at least one rotation assisting feature of each of the contact lenses is configured mirror asymmetrically, about the nose, between the right myopic eye and the left myopic eye such that each rotation assisting feature is selected to allow for different magnitudes of lens rotation between the right and left myopic eyes providing desirable visual performance while maintaining the spatially and temporally varying optical stop signal for the myopic eye such that the efficacy of the directional signal remains substantially consistent over time.

The contact lens pair of one or more of the claims of the example set B can be combined with one or more claim limitations described in one or more of the claim examples set A.

1. A contact lens comprising:
a front surface;
a back surface;
an optical centre;
an optical axis;
an optical zone comprising:
a first region, configured substantially with a single vision power for correction of a myopic eye; and
a second region, a power map characterised by a plurality of meridional power distributions and a plurality of azimuthal power distributions, about its geometric centre;
wherein second region is decentered from the optical centre; and
a non-optical peripheral carrier zone about the optical zone, the non-optical peripheral carrier zone comprising a plurality of azimuthal thickness distributions about the optical axis;
wherein:
at least one of the azimuthal power distributions is partially variant and is devoid of mirror symmetry, within the decentred second region;
at least one of the meridional power distributions is partially variant and is devoid of mirror symmetry, within the decentred second region;
wherein the power map, at least in part, provides a foveal correction for the myopic eye, and at least in part, provides a regional conoid of partial blur, serving as a directional cue, or an optical signal, at the retina of the myopic eye for at least one of slowing, retarding, or reducing myopia progression; and
at least one of the azimuthal thickness distributions is substantially uniform to facilitate on eye rotation of the contact lens on the myopic eye.

2. The contact lens of the claim 1, wherein only one of the plurality of meridional power distributions has mirror symmetry about the geometric centre of the decentered second region; and none of the plurality of the azimuthal power distributions has mirror symmetry about the geometric centre of the decentered second region.

3. (canceled)

4. The contact lens of claim 1, wherein the at least one of the azimuthal power distributions is defined using a cosine distribution of half (½) of a frequency defined with two cosine cycles over 360° or 2π radians.

5. The contact lens of claim 1, wherein a surface area of the second region within the optical zone comprises at least 10% and no greater than 40% of the optical zone; and wherein the surface area of the second region within the optical zone is between 5 and 25 square millimeters.

6. (canceled)

7. The contact lens of claim 1, wherein the geometric centre of the second region is located at least 1.5 mm away from the optical center of the contact lens.

8. (canceled)

9. The contact lens of claim 7, wherein the second region of the optical zone comprises primary spherical aberration between +0.5 D to −0.5D, defined over a minimum diameter of the second region.

10. (canceled)

11. The contact lens of claim 1, wherein a difference between a thickest point and a thinnest point within the plurality of azimuthal thickness distributions of the non-optical peripheral carrier zone about the optical axis provides a peak-to-valley thickness; wherein the peak-to-valley thickness is between 5 μm and 45 μm providing substantial invariance.

12. The contact lens of claim 1, wherein the on eye rotation is gauged as a rotation of the contact lens by 180 degrees at least thrice per 8 hours of lens wear, and at least 15 degrees within 1 hour of lens wear.

13. The contact lens of claim 1, comprising at least one rotation assisting feature; wherein the at least one rotation assisting feature is represented using a periodic function with a periodicity; wherein the periodic function is a saw-tooth profile, a sinusoidal profile, a sum of sinusoidal profiles, or a quasi-sinusoidal profile; wherein the periodicity of the periodic function is no less than 6 defined over 0 to 2π radians, and the rate of thickness change is different for the increase than for the decrease and wherein the maximum thickness variation within the at least one rotation assisting feature is between 10 μm to 45 μm.

14. (canceled)

15. The contact lens of claim 1, wherein the regional conoid of partial blur is not a regular conoid of Sturm and is irregular; wherein the regional conoid of partial blur has a depth of at least 0.5 mm at the retina of the eye, the regional conoid of partial blur spans at a para macular region of the retina of the myopic eye; wherein the regional conoid of partial blur is at least within 15 degrees field of the retina of the myopic eye.

16-17. (canceled)

18. The contact lens of claim 1, wherein the regional conoid of partial blur includes a sagittal plane and a tangential plane; wherein the tangential plane is located in front of the retina for at least one location within 40 degrees field of the retina of the myopic eye; wherein the sagittal plane is located in front of the retina for at least one location within 40 degrees field of the retina of the myopic eye; or wherein the sagittal plane is located substantially close to the retina of the myopic eye, for at least one location within 40 degrees field of the retina of the myopic eye.

19. (canceled)

20. The contact lens of claim 1, wherein the at least one rotation assisting feature is configured to increase rotation on the myopic eye and in combination with the at least partially variant meridional and azimuthal power distribution within the second region, offers a temporally and spatially varying stop signal for the myopic eye such that the efficacy of the directional signal remains substantially consistent over time.

21-32. (canceled)

33. The contact lens of claim 1, wherein the at least one of the partially variant meridional power distributions is radially variant; and wherein the radial power variation in the at least one of the partially variant meridional power distributions is between 0 and −1D.

34. The contact lens of claim 1, wherein the at least one of the plurality of the partially variant meridional power distributions is radially invariant.

35. The contact lens claim 1, wherein the difference between a maximum power and a minimum power within the meridionally varying power distributions across the second region, and the azimuthally varying power distributions about the geometric centre of the second region, provides a delta power; wherein the delta power is between +0.5 D and +2.75 D.

36. The contact lens of claim 1, wherein the plurality of azimuthal thickness distributions are defined with a desired width spanning a range of arbitrary radial distances in the non-optical peripheral carrier zone, wherein the desired width is between 3.5 mm and 7.2 mm, of the non-optical peripheral carrier zone.
